(19) United States
(12) Patent Application Publication
(10) Pub. No.: US 2019/0039310 A1
(43) Pub. Date: Feb. 7, 2019

(54) 3D PRINTING METHODS USING MIXING NOZZLES

(71) Applicant: Voxel8, Inc., Somerville, MA (US)

(72) Inventors: Travis Alexander Busbee, Somerville, MA (US); Carmen M. Graves, Cambridge, MA (US); Andrew Marschner, Somerville, MA (US); John Eugene Minardi, II, Somerville, MA (US); Max Eskin, Somerville, MA (US)

(73) Assignee: Voxel8, Inc., Somerville, MA (US)

(21) Appl. No.: 15/907,128

(22) Filed: Feb. 27, 2018

Related U.S. Application Data
(60) Provisional application No. 62/555,874, filed on Sep. 8, 2017.
(60) Provisional application No. 62/555,886, filed on Sep. 8, 2017.
(60) Provisional application No. 62/464,363, filed on Feb. 27, 2017.

(51) Int. Cl. B29C 64/336; B33Y 10/00; B33Y 30/00; B33Y 50/02; B29C 64/112; B29C 64/209; B29C 64/393; B33Y 70/00; A43B 1/14; A43B 13/04; A43B 23/02; A43B 13/02; A61J 3/06

(52) U.S. Cl. CPC B29C 64/336; B33Y 10/00; B33Y 30/00; B33Y 50/02; B29C 64/112; B29C 64/209; B29L 2031/50; B33Y 70/00; A43B 1/14; A43B 13/04; A43B 23/0215; A43B 13/026; A61J 3/06; B29C 64/393

(57) ABSTRACT

The present invention generally relates to the printing of materials, using 3-dimensional printing and other printing techniques, including the use of one or more mixing nozzles, and/or multi-axis control over the translation and/or rotation of the print head or the substrate onto which materials are printed. In some embodiments, a material may be prepared by extruding material through print head comprising a nozzle, such as a microfluidic printing nozzle, which may be used to mix materials within the nozzle and direct the resulting product onto a substrate. The print head and/or the substrate may be configured to be translated and/or rotated, for example, using a computer or other controller, in order to control the deposition of material onto the substrate.

### FIELD

The present invention generally relates to the printing of materials, using 3-dimensional printing and other printing techniques, including the printing materials and/or the modulation of material composition and material properties through space and/or time.

### BACKGROUND

Three-dimensional (3D) printing is a method of additive manufacturing in which material layers can be successively formed on a substrate in order to manufacture an object. A layer deposited by a method of 3D printing may have a thickness between, for example, 10 micrometers and 1 millimeter. A 3D printed layer may be deposited in a parallel or perpendicular orientation relative to that of the preceding layer. However, 3D printing can be relatively slow or hard to control, and thus, techniques for improved 3D printing are needed.

### SUMMARY

The present invention generally relates to the printing of articles (e.g., of footwear), using 3-dimensional printing and other printing techniques, including the use of one or more mixing nozzles, and/or multi-axis control over the translation and/or rotation of the print head or the substrate onto which the articles are printed. The subject matter of the present invention involves, in some cases, interrelated products, alternative solutions to a particular problem, and/or a plurality of different uses of one or more systems and/or articles.

According one aspect a microfluidic printing nozzle is provided. In some embodiments the microfluidic printing nozzle comprises at least four material inlets in fluid communication with a mixing chamber. In some embodiments, the device comprises an impeller disposed in the mixing chamber. In some embodiments, at least two of the material inlets are each in fluid communication with a discrete rotary positive displacement pump. According to one aspect a device for printing is provided. In some embodiments, the device comprises a first microfluidic printing nozzle comprising a first mixing chamber and a first impeller disposed therein. In some embodiments, the device comprises a second microfluidic printing nozzle comprising a second mixing chamber and a second impeller disposed therein, the second nozzle further comprises an input in fluid communication with an outlet of the first nozzle. In some embodiments, the device comprises a controller configured and arranged to independently control rotation of the first impeller and the second impeller.

According to one aspect, a device for 3D-printing is provided. In some embodiments, the device comprises a microfluidic printing nozzle comprising a mixing chamber and an impeller disposed therein. In some embodiments, the device comprises a heat source or a cooling source in thermal communication with the nozzle. In some embodiments, the device comprises a controller constructed and arranged to control rotation of the impeller.

According to one aspect a multi-axis system for printing an article is provided. In some embodiments the multi-axis system comprises a print head comprising a microfluidic printing nozzle. In some embodiments, the multi-axis system comprises two inlets to the microfluidic printing nozzle. In some embodiments, multi-axis system comprises a substrate. In some embodiments, the print head is configured to deposit a material onto the substrate. In some embodiments, the substrate is configured to be rotated around at least one axis and translated along at least one axis.

According one aspect a device for 3D-printing is provided. In some aspects the device comprises a microfluidic printing nozzle comprising a mixing chamber and an impeller disposed therein. In some embodiments, the device comprises a controller constructed and arranged to control an actuator to laterally move the impeller within the microfluidic printing nozzle.

According to one aspect a method for printing an article is provided. In some embodiments, the method involves flowing a first fluid through a first inlet into a microfluidic printing nozzle. In some embodiments the method involves flowing a second fluid through a second inlet into the microfluidic printing nozzle. In some embodiments, the method involves flowing at least one additional fluid through at least one additional inlet into the microfluidic printing nozzle. In some embodiments the method involves actively mixing the first fluid, the second fluid, and the at least one additional fluid in the microfluidic printing nozzle to form a mixture. In some embodiments, the method involves depositing the mixture onto a substrate. In some embodiments, the method involves pumping two or more materials into a mixing chamber and rotating an impeller to create a mixture of the two or more inputs.

According to one aspect a method of printing of an article is provided. In some embodiments, the method involves receiving object information associated with the article. In some embodiments the method involves identifying, using the object information, characteristics of a target material to be printed at each location of a machine tool path that will be used to create the article. In some embodiments, the method involves identifying two or more input materials to create the target material. In some embodiments, the method involves identifying a set of printer settings for printing the target material. In some embodiments the method involves generating print instructions using the set of printer parameters. In some embodiments the method involves printing the article using the print instructions.

According to one aspect a method of printing an article is provided. In some embodiments the method involves pumping at least four fluids through at least four material inputs of a microfluidic printing nozzle. In some embodiments, the method involves actively mixing the at least four fluids in the microfluidic printing nozzle to form a mixture. In some embodiments, the method involves pumping more than two inputs into a mixing chamber at some point during a print, but only pumping two inputs into the mixing chamber at any particular time. In some embodiments, the method involves continuously changing the pump rotation speeds of more than two inputs during a single print. In some embodiments, the method involves depositing the mixture onto a substrate. In some embodiments, the fluid systems comprise isocyanate prepolymer having an unreacted isocyanate group content ranging from 6 weight percent to 35 weight percent of the whole isocyanate prepolymer weight, and a polyol system or a polyamine system with a number average molecular weight from 100 grams per mole (g/mol) to 10,000 grams per mole.

According to one aspect a method of printing an article is provided. In some embodiments, the method involves flowing at least two materials into a mixing chamber, wherein at least one of the materials is polymeric. In some embodiments, the method involves mixing the at least two materials in the mixing chamber containing an impeller to form a mixture. In some embodiments, the method involves depositing the mixture onto a textile.

According to one aspect a method for printing an article is provided. In some embodiments, the method involves flowing a first fluid through a first inlet and a second fluid through a second inlet into a microfluidic printing nozzle, wherein the first fluid comprises a foam precursor and the second fluid comprises a cell-forming agent. In some embodiments, the method involves homogenously mixing the first fluid and the second fluid to form a mixture. In some embodiments, the method involves printing the mixture onto a substrate.

According to one aspect the method for printing an article is provided. In some embodiments, the method involves flowing a fluid into a microfluidic printing nozzle. In some embodiments, the method involves mixing the fluid with a gas within the microfluidic printing nozzle using an impeller to form a froth comprising bubbles of the gas dispersed within the fluid. In some embodiments, the method involves printing the froth onto a substrate.

According to one aspect the method is provided. In some embodiments, the method involves mixing a first fluid and a second fluid in a mixing chamber to form a foam precursor. In some embodiments, the method involves flowing the foam precursor and a cell-forming agent into a microfluidic printing nozzle. In some embodiments, the method involves rotating an impeller within the microfluidic printing nozzle to form a mixture of the foam precursor and the cell-forming agent. In some embodiments, the method involves printing the mixture onto a substrate.

In another aspect, the present invention is generally directed to a device. In some embodiments, the device is a device for printing, e.g., 3D-printing. According to one set of embodiments, the device comprises a first microfluidic printing nozzle comprising a first mixing chamber and a first impeller disposed therein, a second microfluidic printing nozzle comprising a second mixing chamber and a second impeller disposed therein, the second nozzle further comprising an input in fluid communication with an outlet of the first nozzle, and a controller configured and arranged to independently control rotation of the first impeller and the second impeller.

In another set of embodiments, the device comprises a microfluidic printing nozzle comprising a mixing chamber and an impeller disposed therein, a heat source or a cooling source in thermal communication with the nozzle, and a controller constructed and arranged to control rotation of the impeller.

The device, in another set of embodiments, may be a multi-axis system for printing an article, comprising a print head comprising a microfluidic printing nozzle, two inlets to the microfluidic printing nozzle, and a substrate, wherein the print head is configured to deposit a material onto the substrate, and wherein the substrate is configured to be rotated around at least one axis and translated along at least one axis.

In another set of embodiments, the device may be a multi-axis system for printing an article of footwear, comprising a print head and a substrate, wherein the substrate comprises a footwear last, wherein the print head is configured to deposit a material onto the footwear last, and wherein at least one of the print head and/or the substrate is configured to be rotated around at least one axis and/or translated along at least one axis. In another embodiment, the substrate may comprise a textile attached to a fixture. The fixture may be a flat plate. The fixture may have some curvature. The curvature may be used to cure a polymer in a shape closer to the final shape than it would have been if the substrate had been flat.

The device, in yet another set of embodiments, includes a microfluidic printing nozzle comprising a mixing chamber and an impeller disposed therein, and a controller constructed and arranged to laterally move the impeller within the microfluidic printing nozzle.

In another aspect, the present invention is generally directed to a method. In some cases, the method includes a method for printing an article, e.g., 3D-printing an article. In one set of embodiments, the method includes flowing a first fluid through a first inlet and a second fluid through a second inlet into a microfluidic printing nozzle, where the first fluid comprises a foam precursor and the second fluid comprises a cell-forming agent, homogenously mixing the first fluid and the second fluid to form a mixture, and printing the mixture onto a substrate.

The method, in another set of embodiments, includes flowing a fluid into a microfluidic printing nozzle, mixing the fluid with a gas within the microfluidic printing nozzle using an impeller to form a froth comprising bubbles of the gas dispersed within the fluid, and printing the froth onto a substrate.

In another set of embodiments, the method comprises acts of mixing a first fluid and a second fluid in a mixing chamber to form a foam precursor, flowing the foam precursor and a cell-forming agent into a microfluidic printing nozzle, rotating an impeller within the microfluidic printing nozzle to form a mixture of the foam precursor and the cell-forming agent, and printing the mixture onto a substrate.

In another aspect, a print head is provided. In some embodiments, the print head can have a compressed gas source. In some embodiments, the print head can have a printing nozzle that comprises a mixing chamber, an impeller disposed in the mixing chamber, and two or more material inlets in fluid communication with the mixing chamber. In some embodiments, an outlet of the mixing chamber is configured to intersect with an outlet fluidly connected to the compressed gas source.

In another set of embodiments, a print head is provided. In some embodiments, the print head can have a printing nozzle that comprises a mixing chamber, an impeller disposed in the mixing chamber, and two or more material inlets in fluid communication with the mixing chamber. In some embodiments, the print head can have an ultraviolet (UV) light source adjacent to the printing nozzle.

In another aspect, a method is provided. The method may involve passing a formulation through a print head. The print head may have a compressed gas source, a printing nozzle, and two or more material inlets in fluid communication with the printing nozzle. In some embodiments, an outlet of the printing nozzle is configured to intersect with an outlet fluidly connected to the compressed gas source.

In another set of embodiments, a method is provided. The method may involve passing a formulation through a print head. The print head may have a printing nozzle, two or more material inlets in fluid communication with the printing nozzle, and an ultraviolet (UV) light source adjacent to the printing nozzle.

Other advantages and novel features of the present invention will become apparent from the following detailed description of various non-limiting embodiments of the invention when considered in conjunction with the accompanying figures.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 illustrates a system comprising a nozzle for printing materials, in accordance with one embodiment of the invention;

FIG. 2 illustrates a system comprising a nozzle and a mixing chamber, in another embodiment of the invention;

FIG. 3 illustrates a system comprising multiple mixing chambers, in yet another embodiment of the invention;

FIG. 4 illustrates a variety of inputs that can be mixed, in accordance with certain embodiments of the invention;

FIG. 5 illustrates a system comprising a single input, in accordance with another embodiment of the invention;

FIG. 6 illustrates an input comprising a purge system, in still another embodiment of the invention;

FIG. 7 illustrates a water-blown polyurethane foam in the form of a shoe sole, in one embodiment of the invention;

FIG. 8 illustrates a light microscopy image of a cross-section of a 3D-printed filament, in accordance with another embodiment of the invention;

FIG. 9 illustrates an article with a gradient in properties, in yet another embodiment of the invention;

FIG. 10 illustrates a 3D-printed stimuli-responsive tri-layer polyurethane system in accordance with another embodiment of the invention;

FIG. 11 illustrates an example nozzle architecture, in still another embodiment of the invention;

FIG. 12 illustrates an example material mixing unit architecture, in another embodiment of the invention;

FIGS. 13A-13B illustrate examples of architectures for various subsystems in certain embodiments of the invention;

FIG. 14 is a schematic depiction of a print head and a substrate, according to certain embodiments of the invention;

FIGS. 15-17 are schematic depictions of a multi-axis deposition system, according to certain embodiments of the invention;

FIG. 18 is a non-limiting flow diagram of a method for generating print instructions from object information, in accordance with some embodiments of the invention;

FIG. 19 is a non-limiting flow of calculations to evaluate the required material input ratios to achieve target material properties, in accordance with some embodiments of the invention;

FIG. 20 is a schematic of an illustrative mixing (e.g., reactive) spray print head with an integrated UV curing mechanism, in accordance with some embodiments;

FIG. 21 is a schematic of an illustrative print head with an integrated UV curing mechanism, in accordance with some embodiments; and

FIG. 22 is a schematic of an illustrative spray print head with an integrated UV curing mechanism, in accordance with some embodiments.

### DETAILED DESCRIPTION

The present invention generally relates to the printing of materials, using 3-dimensional printing and other printing techniques, including the printing of materials and/or the modulation of material composition and material properties through space and/or time. In some embodiments, a foam may be prepared by mixing materials within a nozzle, such as a microfluidic printing nozzle, which may be used to direct the resulting product onto a substrate. The nozzle may be controlled, for example, using a computer or other controller, in order to control the deposition of material onto the substrate. In some cases, gases or other materials may be incorporated into the material within the nozzle, e.g., to form a foam.

According to one aspect a method of printing of an article is provided. In some embodiments, the method involves receiving object information associated with the article. In some embodiments the method involves identifying, using the object information, characteristics of a target material to be printed at each location of a machine tool path that will be used to create the article. In some embodiments, the method involves identifying two or more input materials to create the target material. In some embodiments, the method involves identifying a set of printer settings for printing the target material. In some embodiments the method involves generating print instructions using the set of printer parameters. In some embodiments the method involves printing the article using the print instructions.

In some embodiments, the method comprises calculating the ratios of at least two material inputs to a microfluidic printing nozzle required to achieve the target material characteristics in each location, receiving object information comprising target material characteristics at each location of a machine tool path that will be used to create an article, calculating the ratios of at least 2 inputs to a microfluidic printing nozzle required to achieve the target material characteristics in each location. In some embodiments, the method comprises sending commands to a printing system controller that prompts the physical system to pump material from at the least two material inputs at the calculated ratios in order to fabricate the structure with the target material characteristics. In some embodiments, the method comprises sending commands to a printing system controller that prompts the physical system to pump material from at least two material inputs at the calculated ratios in order to fabricate the structure with the target material characteristics. In some embodiments, the system uses at least 3 inputs. In some embodiments, the system uses at least 4 inputs. In some embodiments, the system uses at least 5 inputs. In some embodiments, the system uses at least 6 inputs. In some embodiments, the system uses e.g. at least 7 inputs or 8 inputs.

According to one aspect a method of printing an article is provided. In some embodiments the method involves pumping at least four fluids through at least four material inputs of a microfluidic printing nozzle. In some embodiments, the method involves actively mixing the at least four fluids in the microfluidic printing nozzle to form a mixture. In some embodiments, the method involves depositing the mixture onto a substrate. In some embodiments, the fluid systems comprise isocyanate prepolymer having an unreacted isocyanate group content ranging from 6 weight percent to 35 weight percent of the whole isocyanate prepolymer weight, and a polyol system or a polyamine system with a number average molecular weight from 1000 grams per mole to 7000 grams per mole.

In some embodiments, at least four fluids make up components of a polyurethane elastomer. In some embodiments, at least one of the fluids comprises an isocyanate prepolymer and at least one of the fluids comprises alcohol groups or amine groups. In some embodiments, one of the fluids is an isocyanate prepolymer, and at least three of the fluids comprise molecules with alcohols groups, amine groups, or both. In some embodiments, at least two of the fluids contain polyols or polyamines that differ in molecular weight.

According to one aspect a method of printing an article is provided. In some embodiments, the method involves flowing at least two materials into a mixing chamber, wherein at least one of the materials is polymeric. In some embodiments, the method involves mixing the at least two materials in the mixing chamber containing an impeller to form a mixture. In some embodiments, the method involves depositing the mixture onto a textile.

In some embodiments, the method comprises flowing the at least two materials into the mixing chamber while rotating the impeller in the mixing chamber. In some embodiments, the mixing chamber contains at least a portion of the impeller. In some embodiments, the method comprises flowing the at least two materials into the mixing chamber through at least three discrete material inlets. In some embodiments, the method comprises flowing the at least two materials into the mixing chamber through at least four discrete material inlets. wherein the mixture is a liquid. In some embodiments, the mixture is in direct fluid communication with the mixing chamber during the time of deposition onto the textile, e.g. the mixture is in direct fluid communication with both the mixing chamber, and some part of the textile surface during at least some part of the deposition. In some embodiments, the method comprises controlling the execution of the method using a controller. In some embodiments, the method comprises varying the volumetric flow ratios of the at least two materials based on the spatial location of the mixing chamber with respect to the textile. In some embodiments, the change in the volumetric flow ratios between the at least two materials changes at least one property of the deposited mixture. In some embodiments, at least two of the at least two materials undergo a chemical reaction that changes at least one property of the deposited mixture. In some embodiments, the change in the volumetric flow ratios between the at least two materials changes at least one property of the deposited mixture after a chemical reaction has occurred in the deposited mixture. In some embodiments, the at least one property that has changed is selected from the group consisting of tensile elastic modulus, tensile strength, tensile 100% modulus, hardness, viscosity, dynamic yield stress, static yield stress, density, particle concentration, color, opacity, and surface roughness, or a combination thereof.

In some embodiments, the textile is substantially flat. In some embodiments, the textile conforms to a substrate that is curved in one or more dimensions. In some embodiments, the textile is supported by a belt that can translate the textile in one or more dimensions. In some embodiments, the textile is handled in a roll to roll process. In some embodiments, the textile itself acts as a belt that can move the textile surface with respect to the mixing chamber. In some embodiments, the textile is attached to a fixture. The fixture may be configured to interact with a coupling on the printing system. The fixture may also sit on, or be attached to, a belt that moves the textile or substrate through a sequence of processes.

In some embodiments, the textile is a component of a shoe upper. In some embodiments, the textile is a component of apparel. In some embodiments, the textile is a component of a knit shoe upper. In some embodiments, the textile is a lasted three dimensional shoe upper on a shoe last. In some embodiments, the textile is a lasted full shoe on a shoe last. In some embodiments, at least one of the at least two materials comprises a filler and the article is a polymeric composite. In some embodiments, at least one of the at least two materials comprises isocyanate groups. In some embodiments, at least one of the at least two materials have functional groups selected from the group consisting of alcohol groups, amine groups, or combinations thereof.

In some embodiments, the method comprises flowing a material comprising an isocyanate group through an inlet into the mixing chamber. In some embodiments, the material comprising an isocyanate group is selected from the group consisting of an isocyanate, an isocyanate prepolymer, and a quasi-isocyanate prepolymer, or a combination thereof. In some embodiments, the method comprises flowing a short chain extender through an inlet into the mixing chamber. In some embodiments, the short chain extender has a number average molecular weight of less than 1000 g/mol. In some embodiments, at least 70% of the molecules of the short chain extender have at least two functional groups per molecule. In some embodiments, the at least two functional groups per molecule comprise at least two alcohol groups. In some embodiments, the at least two functional groups per molecule comprise at least two amine groups. In some embodiments, the at least two functional groups per molecule comprise at least one alcohol group and one amine group. In some embodiments, the method comprises flowing a higher molecular weight polyol through an inlet into the mixing chamber. In some embodiments, the method comprises flowing a higher molecular weight polyamine through an inlet into the mixing chamber. In some embodiments, the method comprises flowing a higher molecular weight polyamine through an inlet into the mixing chamber. In some embodiments, least 70% of the molecules have a molecular weight greater than 200 g/mol. In some embodiments, the method comprises flowing polyols with a concentration of added fumed silica greater than 3 percent by weight through an inlet into the mixing chamber. In some embodiments, the method comprises flowing a pigment through an inlet into the mixing chamber. In some embodiments, the method comprises flowing a particle through an inlet into the mixing chamber. In some embodiments, the method comprises flowing molecules having alkene functional groups through an inlet into the mixing chamber.

In some embodiments, the present invention relates to the printing of materials, using 3-dimensional printing and other printing techniques, including the printing of foams and other materials and/or the modulation of material composition and material properties through space and/or time. In some embodiments, a foam may be prepared by mixing materials within a nozzle, such as a microfluidic printing nozzle, which may be used to direct the resulting product onto a substrate. The nozzle may be controlled, for example, using a computer or other controller, in order to control the deposition of material onto the substrate. In some cases, gases or other materials may be incorporated into the material within the nozzle, e.g., to form a foam.

According one aspect a microfluidic printing nozzle is provided. In some embodiments the microfluidic printing nozzle comprises at least four material inlets in fluid communication with a mixing chamber. In some embodiments, the device comprises an impeller disposed in the mixing chamber. In some embodiments, at least two of the material inlets are each in fluid communication with a discrete rotary positive displacement pump.

In some embodiments, at least one, at least two, at least three, at least four, and/or the at least four material inlets are each in fluid communication with a discrete rotary positive displacement pump. In some embodiments, at least one, at least two, at least three, at least four, and/or each of the rotary positive displacement pumps comprises e.g. an auger, a gear pump, a progressive cavity pump, a micro-annular gear pump, a rotary lobe pump, a vane pump, a screw, a Lobe pump, a Cam pump, a Peristaltic pump, or combinations thereof. In some embodiments, the article comprises at least a second gear pump. In some embodiments, at least some of the pumps that push material through the inlets comprise gear pumps. In some embodiments, the article comprises at least a second progressive cavity pump. In some embodiments, at least some of the pumps comprise progressive cavity pumps. In some embodiments, the rotary positive displacement pump comprises e.g. a rotary lobe pump, a vane pump, a screw, a Lobe pump, a Cam pump, a Peristaltic pump. In some embodiments, at least some of the pumps comprise e.g. Lobe pumps, Cam pumps, or Peristaltic pumps, or combinations thereof. In some embodiments, at least one inlet is in fluid communication with a rotary positive displacement pump, e.g. a progressive cavity pump, a gear pump, an auger, a rotary lobe pump, or a vane pump. In some embodiments, at least four of the rotary positive displacement pumps each comprise a progressive cavity pump. In some embodiments, the progressive cavity pump is operated by a controller that is in communication with a computer.

In some embodiments, the article comprises four or more inlets to the mixing chamber. In some embodiments, at least one of the inlets, at least two of the inlets, at least three of the inlets, or at least four of the inlets are each connected to a respective rotary positive displacement pump. In some embodiments, e.g. at least four material inputs or at least five material inputs are each in fluid communication with a discrete rotary positive displacement pump. In some embodiments, at least e.g. 4, 5, 6, 7, or 8 material inputs are in fluid communication with a discrete rotary positive displacement pump.

In some embodiments, at least one of the material inlets is outfitted with a mechanical valve adjacent to the mixing chamber. In some embodiments, the mechanical valve comprises e.g. a needle valve, a pinch valve, a spool valve, or a ball valve, or combinations thereof. In some embodiments, the mechanical valve is a passive one-way valve. In some embodiments, the mechanical valve is an active valve with a linear actuator.

In some embodiments, the volume of the mixing chamber is from 30 nanoliters (nL) to 500 microliters. In some embodiments, the volume of the mixing chamber is e.g. less than 400 microliters, less than 300 microliters, less than 200 microliters, less than 100 microliters, less than 50 microliters.

In some embodiments, the article further comprises e.g. at least five, at least six, at least seven, or at least eight material inputs in fluid communication with a mixing chamber.

In some embodiments, each of the material inlet pumps and the impeller motor is in electrical communication with a controller.

In some embodiments, the microfluidic printing nozzle has at least one input at a upstream location with respect to the flow direction of the microfluidic nozzle, with respect to the other material inlets. In some embodiments, at least one of the mixing chamber, and/or the material inlet channels comprises a pressure transducer in sensing communication with the controller. In some embodiments, the microfluidic printing nozzle contains at least one of a heat source and/or a temperature measuring device, in communication with the controller. In some embodiments, the output of the mixing chamber branches into a multi-nozzle array consisting of at least two material outlets. In some embodiments, the impeller can be actuated relative to the mixing chamber to close off the exit to the mixing nozzle, acting as a needle valve. In some embodiments, the impeller can be actuated relative to the mixing chamber to change the volume of the mixing chamber. In some embodiments, the mixing chamber is a separate body that is removable. In some embodiments, both the mixing chamber and the impeller are removable and designed to be used as a pair. In some embodiments, different impeller and mixing chamber combinations might be used for different target material flowrates.

In some embodiments, the article comprises three inlets, or at least four inlets to the microfluidic printing nozzle. In some embodiments, the article comprises a valve configured to control the flow of at least one input through an inlet to the microfluidic printing nozzle. In some embodiments, the article comprises five valves, wherein each inlet to the microfluidic printing nozzle has at least one valve controlling the flow of at least one input through the inlet. In other embodiments, one or more valves may be configured to relieve any internal pressure that has built up in the article after flow has stopped.

In some embodiments, the substrate comprises a footwear last. In some embodiments, a textile is disposed on the substrate. In some embodiments, the textile is a component of an article of footwear. In some embodiments, the textile is an upper. In some embodiments, the textile is an article of apparel. In some embodiments, the textile is a component of a sporting good (e.g., bag, glove, grip, tent).

In some embodiments, the article comprises e.g. two, three, four inlets to the print head. In some embodiments, the article comprises a valve configured to control the flow of at least one input through an inlet to the microfluidic printing nozzle. In some embodiments, the article comprises five valves, wherein each inlet to the microfluidic printing nozzle has at least one valve controlling the flow of at least one input through the inlet. In some embodiments, the article comprises the flow of at least one input through at least one inlet is pneumatically controlled.

According one aspect a device for 3D-printing is provided. In some aspects the device comprises a microfluidic printing nozzle comprising a mixing chamber and an impeller disposed therein. In some embodiments, the device comprises a controller constructed and arranged to control an actuator to laterally move the impeller within the microfluidic printing nozzle.

In some embodiments, the controller is constructed and arranged to control a motor that drives rotation of the impeller. In some embodiments, the controller is constructed and arranged to control the actuator to laterally move the impeller within the microfluidic printing nozzle while simultaneously controlling the motor to rotate the impeller. In some embodiments, the impeller is constructed and arranged to be movable to block an outlet of the microfluidic printing nozzle. In some embodiments, movement of the impeller within the microfluidic printing nozzle alters the free volume of the microfluidic printing nozzle.

Some embodiments are directed to methods of printing an article, which may include flowing at least two materials into a mixing chamber. In some embodiments, at least one of the materials is polymeric. The method may involve in some embodiments mixing the at least two materials in the mixing chamber containing an impeller to form a mixture. The method may also include depositing the mixture onto a textile. In some embodiments, the mixed material flows through an orifice and onto the surface of a textile.

In some embodiments, the method may involve flowing the at least two materials into the mixing chamber while rotating the impeller in the mixing chamber. In some embodiments, the mixing chamber contains at least a portion of the impeller. The term “mixing chamber” may refer to the volume in which the at least two materials that are mixed together occupy from when they first touch each other, to when they stop being mechanically influenced by active motion of a mixing part (e.g., impeller). In some embodiments, the mixing chamber and the impeller share at least some volume, e.g. the impeller occupies at least some of the dead volume of the mixing chamber.

In some embodiments, the method may involve flowing the at least two materials into the mixing chamber through at least three discrete material inlets. In such embodiments, there may be at least three materials flowed into the mixing chamber. In some embodiments, the method may involve flowing the at least two materials into the mixing chamber through at least four discrete material inlets. In such embodiments, there may be at least three or four or more materials flowed into the mixing chamber. In some embodiments, a ratio (e.g., a volume ratio, a weight ratio) between the 2, 3, 4, or more materials may be changed with time.

In some embodiments, the mixture is a liquid. In some embodiments, the mixture is a viscoelastic complex fluid. In some embodiments the mixture is in direct fluid communication with the mixing chamber during the time of deposition onto the substrate (e.g., textile). As a non-limiting example, the mixture is not jetted into discrete droplets from a standoff distance from the substrate (e.g., textile), but instead contacts simultaneously an outlet from the mixing chamber (e.g., nozzle orifice) and the substrate (e.g., textile) while the mixture is continuous with itself. In some embodiments, the mixture may not be in direct fluid communication with the substrate. As a non-limiting example, an outlet of the mixing chamber may intersect with a compressed gas stream that atomizes the mixture into discrete droplets and propels them towards the substrate. In some embodiments, a single print may include regions of the print where a material (e.g., a mixture) in the mixing chamber is in direct fluid communication with the substrate, and other regions where a material (e.g., a mixture) is not in direct fluid communication with the substrate (e.g. some parts are extruded onto the substrate, and other parts are sprayed onto the substrate from a distance, respectively). In some embodiments, a material (e.g., a mixture) that is sprayed may be injected into the mixing chamber from different inputs than a material (e.g., a mixture) that is extruded.

In some embodiments, the method may involve controlling the execution of the method using a controller. The method may involve varying the volumetric flow ratios of the at least two materials based on the spatial location of the mixing chamber with respect to the textile. In some embodiments, the change in the volumetric flow ratios between the at least two materials changes at least one property of the deposited mixture. In some embodiments, at least two of the at least two materials undergo a chemical reaction that changes at least one property of the deposited mixture. In some embodiments, the change in the volumetric flow ratios between the at least two materials changes at least one property of the deposited mixture after a chemical reaction has occurred in the deposited mixture. The change in the volumetric flow ratios between the two or more materials may influence the properties of the deposited structure before all chemical reactions have occurred, after all chemical reactions have occurred, or both before and after chemical reactions. In some embodiments, the at least one property that has changed is selected from the group consisting of tensile elastic modulus, tensile strength, tensile 100% modulus, hardness, viscosity, dynamic yield stress, static yield stress, density, particle concentration, color, opacity, and surface roughness, or a combination thereof.

In some embodiments, the textile onto which the mixture is deposited is substantially flat. In some embodiments, the textile conforms to a substrate that is curved in one or more dimensions (e.g., two or three dimensions). In some embodiments, the textile is supported by a belt that can translate the textile in one or more dimensions (e.g., two or three dimensions). In some embodiments, the textile is handled in a roll to roll process. In some embodiments, the textile itself acts as a belt that can move the textile surface with respect to the mixing chamber. In some embodiments, the textile is a component of a shoe upper. In some embodiments, the textile is a component of apparel. In some embodiments, the textile is a component of a knit shoe upper.

In certain cases, a mixture may be deposited onto an article disposed on a substrate. The article may be a component of an article of footwear (e.g., an upper), or may be an article of footwear (e.g., a shoe). The substrate may be configured to hold the article in an advantageous shape, such as an advantageous shape for footwear applications. In some embodiments, the substrate may be a shoe last. Non-limiting examples of suitable combinations of substrates and articles include but are not limited to lasted three dimensional shoe uppers on shoe lasts and lasted full shoes on shoe lasts, textiles cut into a shape of upper flat patterns in a flat form factor, and textiles cut into a shape of upper flat patterns disposed onto a substrate that is curved in at least one dimension. Other types of articles and substrates are also possible.

In some embodiments, at least one of the at least two materials comprises a filler and the article is a polymeric composite. In some embodiments, at least one of the at least two materials comprises isocyanate groups. In some embodiments, at least one of the at least two materials have functional groups (e.g., chemical functional groups) selected from the group consisting of alcohol groups, amine groups, or combinations thereof. In some embodiments, the method may involve flowing a material comprising an isocyanate group through an inlet into the mixing chamber. In some embodiments, the material comprising an isocyanate group is selected from the group consisting of an isocyanate, an isocyanate prepolymer, and a quasi-isocyanate prepolymer, or a combination thereof. In some embodiments, the method may involve flowing a short chain extender through an inlet into the mixing chamber. In some embodiments, the short chain extender has a number average molecular weight of e.g. less than 5000 g/mol, less than 4000 g/mol, less than 3000 g/mol, less than 2000 g/mol, less than 1000 g/mol, less than 500 g/mol, less than 100 g/mol, or less than 90 g/mol. In some embodiments, the chain extender is butanediol with a molecular weight of 90.12 g/mol. In some embodiments, the short chain extender has a number average molecular weight of less than 1000 g/mol. In some embodiments, e.g. at least 20%, at least 30%, at least 40%, at least 50%, at least 60%, at least 70%, at least 80%, or at least 90%, or at least 99% of the molecules of the short chain extender have at least two functional groups per molecule. In some embodiments, at least 70%, of the molecules of the short chain extender have at least two functional groups per molecule. In some embodiments, the at least two functional groups per molecule comprise at least two alcohol groups. In some embodiments, the at least two functional groups per molecule comprise at least two amine groups. In some embodiments, the at least two functional groups per molecule comprise at least one alcohol group and one amine group. In some embodiments, the method may involve flowing a higher molecular weight (e.g., number average molecular weight) polyol and/or polyamine through an inlet into the mixing chamber (e.g., molecular weight e.g. greater than 100 g/mol, greater than 200 g/mol, greater than 300 g/mol, greater than 400 g/mol, or greater than 500 g/mol). In some embodiments, e.g. at least 20%, at least 30%, at least 40%, at least 50%, at least 60%, at least 70%, at least 80%, or at least 90%, or at least 99% of the molecules have a molecular weight greater than 200 g/mol. In some embodiments, at least 70% of the molecules have a molecular weight greater than 200 g/mol. In some embodiments, the method may involve flowing polyols with a concentration of added fumed silica e.g. greater than 0.1 percent by weight, greater than 2 percent by weight, greater than 3 percent by weight, greater than 4 percent by weight, greater than 5 percent by weight, greater than 10 percent by weight, greater than 20 percent by weight, greater than 30 percent by weight, greater than 40 percent by weight, greater than 50 percent by weight, greater than 60 percent by weight, greater than 70 percent by weight through an inlet into the mixing chamber. In some embodiments, the method may involve flowing polyols with a concentration of added fumed silica greater than 3 percent by weight through an inlet into the mixing chamber.

In some embodiments, one or more material inputs may comprise a polymer, oligomer, or monomer that is at least partially curable through exposure to light (e.g., ultraviolet (UV) irradiation). In a non-limiting example, an input may comprise both molecules with alcohol functional groups and molecules with acrylate, methacrylate, or vinyl functional groups. Examples of suitable UV-curable molecules may include molecules (e.g., urethane acrylates) that contain two or more urethane bonds and 2 or more functional groups containing alkenes (e.g., acrylates, methacrylates, vinyls). A non-limiting example of a urethane acrylate is:

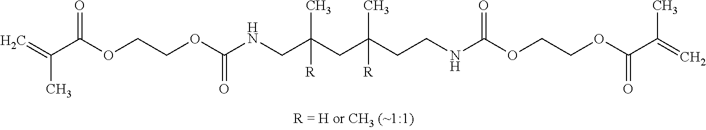

One or more material inputs may comprise one or more free radical photoinitiators. In some embodiments, a single input may include more than 1%, more than 10%, more than 20%, more than 40%, more than 60%, or more than 80% UV-curable molecules. In some embodiments, a single input may include 100% UV-curable molecules. In certain embodiments, a material input that has a high percentage of UV curable components may be blended with other inputs with little to no UV curable components to obtain a mixture that is partially UV-curable. In certain embodiments, the UV-curable component may be exposed to UV irradiation after the component exists the nozzle to change one or more properties (e.g., viscosity, green strength, or yield stress) of the mixture. In some embodiments, the microfluidic print head may be outfitted with a UV irradiation source for the purpose of curing the UV-curable component of the mixture as it exits (e.g., is extruded or sprayed from) the mixing chamber. In some embodiments, the UV irradiation source may be focused at an outlet (e.g., the tip) of the nozzle so that the mixture increases in viscosity immediately upon exiting the nozzle. In certain embodiments, a material (e.g., mixture) may be exposed to UV light inside of the mixing chamber. In other embodiments, the UV light source may be configured to expose an area adjacent to, but not including, the nozzle outlet (e.g., tip) so that the mixture has a controlled amount of time to flow before exposure to UV light. In some embodiments, the UV-curable component of the system may act as a rheological modifier (e.g., instead of or in addition to fumed silica).

In some embodiments, additional material inlets may be utilized to control the insertion of pigments of dyes to control the RGB color of the deposited material. In some embodiments, the method may involve flowing a pigment and/or a particle through an inlet into the mixing chamber. Any of the materials flowed into the mixing chamber may also contain pigments and/or particles. In some embodiments, the pigments and/or particles may be flowed into the mixing chamber while contained in a fluid in a pigment and/or particle concentration of e.g. greater than 1 percent by weight, greater than 2 percent by weight, greater than 3 percent by weight, greater than 4 percent by weight, greater than 5 percent by weight, greater than 10 percent by weight, greater than 20 percent by weight, greater than 30 percent by weight, greater than 40 percent by weight, greater than 50 percent by weight, greater than 60 percent by weight, greater than 70 percent by weight.

In one non-limiting set of embodiments, one material that is flowed into the mixing chamber, Part A, is the curing agent that binds another three materials together. In one non-limiting set of embodiments, there are three different Part B's flowed into the mixing chamber along with Part A: Part B1, which makes the mixture stiff during or after Part B1 is introduced into the mixing chamber; Part B2 makes the mixture soft and low viscosity during or after Part B2 is introduced into the mixing chamber; and Part B3 makes the mixture soft and have high viscosity during or after Part B3 is introduced into the mixing chamber. The volumetric flow rate ratios for B1 to B2 to B3 into the mixing chamber can be controlled to control properties (e.g., stiffness and viscosity) of the mixture. The volumetric flow rate of A into the mixing chamber can be determined, e.g. based on what is necessary to complete all chemical reactions for the ratio of Part B's, and controlled by a controller.

According to one aspect a method for printing an article is provided. In some embodiments, the method involves flowing a first fluid through a first inlet into a microfluidic printing nozzle. In some embodiments the method involves flowing a second fluid through a second inlet into the microfluidic printing nozzle. In some embodiments, the method involves flowing at least one additional fluid through at least one additional inlet into the microfluidic printing nozzle. In some embodiments the method involves actively mixing the first fluid, the second fluid, and the at least one additional fluid in the microfluidic printing nozzle to form a mixture. In some embodiments, the method involves depositing the mixture onto a substrate.

In some embodiments the first fluid contains isocyanate functional groups. In some embodiments, the first fluid contains an isocyanate prepolymer. In some embodiments the first fluid contains a quasi-isocyanate prepolymer.

In some embodiments the second fluid contains alcohol functional groups and/or amine functional groups. In some embodiments the second fluid and the at least one additional fluid contain alcohol functional groups and/or amine functional groups. In some embodiments ratios between the first fluid, the second fluid, and the at least one additional fluid are varied, based on the location of the microfluidic printing nozzle with respect to the substrate, to modulate at least one property of the material that is deposited zonally. In some embodiments ratios between the first fluid, the second fluid, and the at least one additional fluid are varied, based on the location of the microfluidic printing nozzle with respect to the substrate, to modulate the physical properties of the material that is deposited zonally.

In some embodiments, ratios between the first fluid, the second fluid, and the at least one additional fluid are modulated to control at least one property selected from the group consisting of cured material stiffness, uncured or partially uncured material viscosity, uncured or partially uncured material yield stress, material cure rate, material color, density, pore size, filler content, opacity, and surface roughness, or a combination thereof. In some embodiments, the ratios between the first fluid, the second fluid, and the at least one additional fluid are modulated to control at least two properties selected from the group consisting of cured material stiffness, uncured material viscosity, uncured material yield stress, material cure rate, material color, density, pore size, filler content, opacity, and surface roughness, or a combination thereof. In some embodiments, ratios between the first fluid, the second fluid, and at least two additional fluids are modulated to control at least two properties selected from the group consisting of cured material stiffness, uncured material viscosity, uncured material yield stress, material cure rate, material color, density, pore size, filler content, opacity, and surface roughness, or a combination thereof.

In some embodiments, the method comprises flowing a pigment or dye contained in a third fluid into the microfluidic printing nozzle. In some embodiments the method comprises flowing a pigment or dye concentrate where the pigment or dye is suspended in a third fluid into the microfluidic printing nozzle. In some embodiments the method comprises flowing a pigment or dye contained in the first fluid into the microfluidic printing nozzle. In some embodiments, the method comprises the first fluid comprises polyols or polyamines as the carrier fluid. In some embodiments, the method comprises flowing at least one fluid, each comprising a pigment or dye, into the microfluidic printing nozzle. In some embodiments, the method comprises flowing at least two fluids, each comprising a pigment or dye, into the microfluidic printing nozzle, and modulating the volumetric flow rate ratios of the fluids comprising a pigment or dye to achieve a defined color profile in the printed article. In some embodiments, the method comprises flowing at least two fluids, each comprising a pigment or dye, into the microfluidic printing nozzle wherein the volumetric flow rate ratios of the fluids comprising a pigment or dye are modulated to achieve a defined color profile in the printed article. In some embodiments, the pigment or dye has a color selected from the group consisting of: Black, Yellow, Magenta, Cyan, and White, or a combination thereof. In some embodiments, the method comprises flowing at least three fluids, each comprising a pigment or dye, into the microfluidic printing nozzle.

In some embodiments, the first fluid comprises a polyol concentrate comprising an additive. In some embodiments, an additive to modify at least one property of the printed article is incorporated into a polyol concentrate. In some embodiments, the additive is a catalyst. In some embodiments, the additive is a catalyst, for example to control cure speed. In some embodiments, the additive is water. In some embodiments, additive is water, for example to control foaming and density. In some embodiments, the additive is a blowing agent. In some embodiments, the additive is a blowing agent, for example to control latent expansion. In some embodiments, the additive is a heat activated expandable particle. In some embodiments, the additive is a heat activated expandable particle, for example to influence surface gloss and roughness. In some embodiments, the additive is a light curable (e.g., UV-curable) compound that can be rapidly cured on exposure to light (e.g., UV light) after exiting the nozzle. In some embodiments, the additive is a combination of light-curable (e.g., UV-curable) resins and free radical photoinitiators. In some embodiments, the additive is an adhesion promoter. In some embodiments, the additive is an adhesion promoter including but not limited to silane compounds to improve adhesion to various substrates including but not limited to polyester fabrics, textiles, rubbers, thermoplastics. In some embodiments, the additive is selected from the group consisting of UV absorber, light stabilizer, antioxidant, or combination thereof. In some embodiments, the additive is e.g. a UV absorber or light stabilizer or antioxidant to impart protection against color change and property deterioration as a result of exposure to heat and light.

In some embodiments, the method comprises flowing an input comprising a release agent into the microfluidic printing nozzle. In some embodiments, one input to the microfluidic printing nozzle system is a release agent that prevents the printed article from adhering to the substrate.

In some embodiments, the substrate is a textile. In some embodiments, the textile is an upper for athletic footwear. In some embodiments, the textile is a component of apparel. In some embodiments that substrate is a leather, or a synthetic leather or polymer film.

For instance, certain aspects of the invention are generally directed to devices for 3D-printing. Generally, in 3D-printing, material is controllably deposited, e.g., on a substrate, to create a product. The material may be deposited in a pattern defining the product, or that can be manipulated to create the product, e.g., by removing portions of the pattern. In some cases, a printing nozzle, such as a microfluidic printing nozzle, may be used to direct material onto a substrate. The nozzle may be controlled, for example, using a computer or other controller, in order to control the deposition of material onto the substrate.

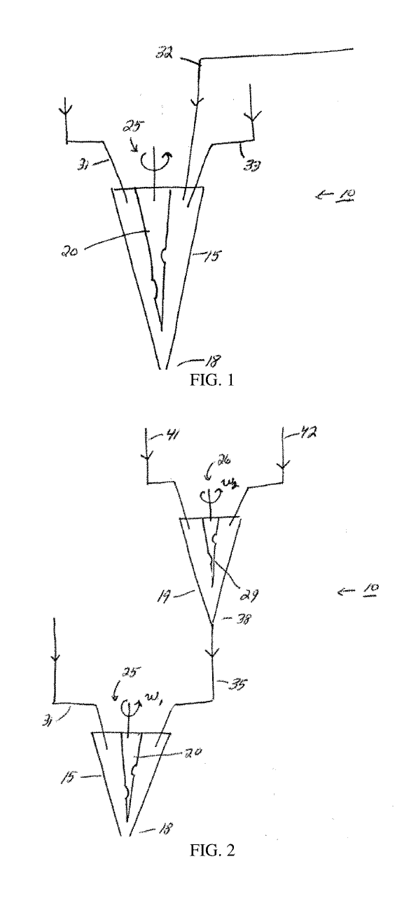

One example of an embodiment of the invention is now described with respect to FIG. 1. As will be discussed in more detail below, in other embodiments, other configurations may be used as well. In this figure, a device 10 for printing an article is shown, using techniques such as 3D printing. The device may include a nozzle 15, through which material is directed at a substrate through outlet 18, e.g., through a valve. The substrate may be planar, or in some cases, the substrate may have a different shape. The substrate may thus be any suitable target for a material exiting the nozzle. For instance, the substrate may include a mold to which the material is applied. Nozzle 15 in FIG. 1 is generally depicted as being conical or funnel-shaped, although it should be understood that this is by way of example only, and the nozzle may have any suitable shape able to direct a material at a substrate.

One or more fluids may flow into the nozzle, and in some embodiments, mixed within the nozzle, e.g., within a mixing chamber within the nozzle to form the material to be deposited on the substrate. In some cases, active mixing may be used to mix fluids within the nozzle. For example, as is shown in FIG. 1, an impeller 20 may be spun to cause mixing within the nozzle. The impeller may have any size or shape, as discussed below. In some cases, the impeller, when spun, may substantially conform to the mixing chamber, or at least a part of the mixing chamber. Thus, for example, material flowing through the nozzle may be disrupted through spinning of the impeller (depicted in FIG. 1 as arrow 25), thereby causing mixing of the material to occur. In some embodiments, the nozzle outlet may be surrounded by a compressed gas sheath. The compressed gas sheath may guide a gas stream to intersect with the outlet of the nozzle. The gas stream may be configured to atomize a material (e.g., a mixture) that exits (e.g., is extruded from) the nozzle. The atomized material may be ejected towards the substrate. The atomized material (e.g., atomized mixture) may land on the substrate such that it forms a film of material. In some cases, the nozzle may protrude from the compressed gas sheath, such that a material (e.g., a mixture) exiting (e.g., extruded from) the nozzle can be either atomized or not atomized depending on whether the compressed gas is flowed through the compressed gas sheath. In some cases, the compressed gas sheath may be in direct fluid communication with either a valve, or a pressure regulator, or both.

In some embodiments, as discussed herein, the speed of the impeller may be controlled, e.g., by a computer or other electronic controller, to control the mixing and/or direction of material exiting the nozzle. For example, the controller may control a valve or other apparatus to control the exiting of material from the nozzle, for example, as the nozzle moves relative to a substrate (or equivalently, as the substrate moves relative to the nozzle). Control of nozzle mixing and the position of the nozzle relative to the substrate may thus be used to control 3D-printing of a material onto the substrate.

In addition, in some embodiments, the material within the nozzle may be subjected to heating or cooling. This may, for example, be used to control mixing and/or reaction within the material, to keep the temperature at substantially the temperature of the surrounding environment (e.g., at room temperature), to prevent the surrounding environmental conditions and/or the heat generated by friction of the impeller and exotherm of the material curing from affecting the reaction or the printing parameters, or the like. Any method may be used to heat or cool the material within the nozzle. For example, heating or cooling may be applied to the nozzle itself, and/or to material within the nozzle. Non-limiting examples include electrical heating, Peltier cooling, application of infrared light, or other techniques such as those discussed herein.

As mentioned, one or more fluids may enter the nozzle to be mixed together. The fluids may enter via a common inlet, and/or via separate inlets, for example, as is illustrated in FIG. 1 with inlets 31, 32, and 33. Although 3 inlets are illustrated in this figure, this is by way of example only, and in other embodiments, more or fewer inlets are also possible. The inlets may independently be at the same or different distances away from an outlet of the nozzle. In some cases, the fluids may react upon contact with each other; thus, the fluids are kept separate prior to entrance into the nozzle, for example, using one or more inputs and/or valves to control contact of the fluids with each other. For example, one or more valves may be present on one or more of the inlets to control the flow of fluid through the inlets, e.g., into the nozzle. Examples of valves that can be used include needle valves, ball valves, gate valves, butterfly valves, or other suitable types of valves. Additionally, other types of apparatuses to control fluid flow may also be used, in addition to and/or instead of valves.

A non-limiting example of a supplemental step in a method includes curing any latent curing agents agent (e.g., a latent curing agent configured to be activated by exposure to light and/or heat) that may be present within a mixture, printed mixture, material, layer, and/or 3D-printed article. In some embodiments, a latent curing agent may initially be present in a first fluid input or second fluid input and may be incorporated into the mixture, printed mixture, material, layer, and/or 3D-printed article in an uncured form. The mixture, printed mixture, material, layer, and/or 3D-printed article may be removed from a vessel (e.g., extruded from a mixing chamber and/or mixing nozzle) and then exposed to a stimulus, such as light and/or heat, that results in the curing of the latent curing agent. Curing the latent curing agent may e.g. increase the strength of a 3D-printed article, increase the density of the 3D-printed article, and/or may improve the surface finish of the 3D-printed article. The latent curing agent may be a blocked isocyanate such as blocked toluene diisocyanate. The latent curing agent may make up to 70% by weight of a fluid input. In some cases the print head may be configured to deliver a stimulus (e.g., light, e.g., UV irradiation) to the material immediately as it exits the outlet (e.g., tip) of the nozzle.

In some embodiments, an active mixing system may be applied to one part latent curing polymer systems. In these one part latent curing polymer systems, polymers may have little to no reactivity in the storage state or in the cartridge. In some embodiments, it is not until the one part latent curing polymer system is deposited and experiences a stimulus that it will begin to polymerize into a solid thermoset or elastomer. In such embodiments, multiple one part systems that have compatibility with one another can be used as inputs into the microfluidic active mixing nozzle system. In some embodiments, each one part system may have a different material property or properties, e.g. stiffness, density, filler content, and/or blowing agent content. In some embodiments, the ratios between two or more inputs can be varied to modulate these properties. It should be understood that any of the embodiments relating to multi-part reactive systems may also be applied to the active mixing of one part systems to vary material properties.

In some embodiments, one or more inputs (e.g., materials, fluids; e.g., to a microfluidic printing nozzle) comprises a one part resin that is configured to polymerize in response to a stimulus. In some embodiments, the resin comprises, e.g., polyols with blocked isocyanates, and/or a polyurethane with silane terminal groups. In some embodiments, the stimulus is e.g., heat, moisture, and/or light.

There are several types of systems (e.g., 1K systems) that could be blended using a one part latent curing polymer system. As a non-limiting example of a system (e.g., 1K systems) that could be blended using a one part latent curing polymer system, a polyol or polyamine system with blocked isocyanate could be used. In some embodiments, a polyol or polyamine system with blocked isocyanate functions similarly to e.g. a standard polyurethane system, a polyuria system, or a polyurethane/polyuria hybrid system. In the case of a polyol or polyamine system with blocked isocyanate, the curing agent is blocked with another functional group, so the curing agent can be integrated directly into the polyol or polyamine in the cartridge without curing. Heat can then be used to deblock the isocyanate and drive rapid curing after all of the materials have been deposited.

As another non-limiting example of a system (e.g., 1K systems) that could be blended using a one part latent curing polymer system, silane hybrid chemistry could be used. In the case of silane hybrid chemistry, the polyols and/or isocyanates are functionalized with a terminal silane group. The silane group may be e.g. alpha-Dimethoxysilane, gamma-trimethoxy silane, gamma-triethoxy silane, gamma-dimethoxy silane, or gamma diethoxy silane. In these cases, the silanes polymerize with each other on exposure to moisture, and the reaction is accelerated by heat. After a part is printed, it may be exposed to high humidity and high heat to accelerate the reaction. Another example is an isocyanate prepolymer that may be cured by exposure to moisture.

As still another non-limiting example of a system (e.g., 1K systems) that could be blended using a one part latent curing polymer system, radiation curable formations could be used. In some embodiments, these radiation curable formations may comprise acrylates, and/or methacrylate functional polymers with free radical photoinitiators. In some cases, the free radical photo initiators can be activated by exposure to UV after the formulations are deposited. In other cases, the latent curing polymer system may be a combination of photocurable resins and 1K polyurethane systems. These two separate components of the latent curing polymer system may be blended together in the mixing chamber.

Carbodiimides could be used, as still another non-limiting example of a system (e.g., 1K systems) that could be blended using a one part latent curing polymer system. In some embodiments, carbodiimides can act as a latent curing agent that forms chemical bonds with carboxylic acid groups or amine groups on exposure to heat. In some cases, carbodiimides could be used as a cross-linker for polyamine systems.

In another non-limiting example of a system (e.g., 1K systems) that could be blended using a one part latent curing polymer system, moisture cure polyurethane (PU) could be used. In some cases isocyanate prepolymers, or polyols that have been capped with free isocyanate groups, may be used as the one part system. In some embodiments, the one part system will then be stable until it is exposed to moisture in the air that will drive the reaction between free isocyanate groups.

As a non-limiting example, in one set of embodiments, two or more fluids may be mixed together to form product on a substrate, for example, a foam. In some cases, a material (e.g., a precursor to the foam) may be deposited on a substrate in a partially fluid state, where the material is able to harden to form the product on the substrate. For instance, the material may have a viscosity of less than 1,000,000 cP, less than 500,000 cP, less than 300,000 cP, less than 100,000 cP, less than 50,000 cP, less than 30,000 cP, less than 10,000 cP, less than 5,000 cP, less than 3,000 cP, less than 1,000 cP, less than 500 cP, less than 300 cP, less than 100 cP, less than 50 cP, less than 30 cP, or less than 10 cP. In some cases, the material may have a viscosity of at least 10 cP, at least 30 cP, at least 50 cP, at least 100 cP, at least 300 cP, at least 500 cP, at least 1,000 cP, at least 3,000 cP, at least 5,000 cP, at least 10,000 cP, at least 30,000 cP, at least 50,000 cP, at least 100,000 cP, at least 300,000 cP, at least 500,000 cP, or at least 1,000,000 cP. Combinations of any of these viscosities are also possible; for example, the viscosity of a material may be between 100 cP and 500 cP. The material may form a product passively (e.g., upon drying of the material, completion of a reaction forming the product, etc.), and/or additional steps may be taken to encourage formation of the product. As various non-limiting examples, heat may be applied to the material and/or to the substrate, light (e.g., ultraviolet light) may be applied to the material to cause a chemical reaction, etc.

In some embodiments, a foam may be prepared by mixing a polymer, a cross-linking reagent, and a cell-forming agent, e.g., within a printing nozzle such as is shown in FIG. 1. These may be added sequentially or simultaneously in various embodiments, e.g., as discussed herein. For instance, in FIG. 1, a cross-linking agent may be added to the nozzle via inlet 31, a cell-forming agent may be added via inlet 32, and a polymer may be added via inlet 33. In some cases, these may be flowable at the temperatures in which they enter the nozzle. In some cases, control of these may be controlled using one or more valves or other apparatuses on any of these inlets, optionally controlled by a computer or other controller.

One example of a suitable polymer is polyurethane; one example of a cross-linking reagent is isocyanate; and one example of a cell-forming agent is water (which can react with the isocyanate to produce carbon dioxide as the foam forms). Other examples of each of these are discussed in more detail below. In addition, it should be understood that other fluids or reactants may be combined to form a foam, and the invention is not limited to only embodiments that include a polymer, a cross-linking reagent, and a cell-forming agent; see below for additional non-limiting examples. For example, as discussed below, a foam may be prepared using a polymer and a cell-forming agent, but not necessarily a cross-linking agent. In some embodiments, other additives may also be introduced, for example, surfactant, silicone surfactant, UV stabilizer, catalyst, pigment, nucleation promotors, fillers for better abrasion resistance, chemical foaming agents, etc. In addition, other products besides foam may be formed in other embodiments.

It should be understood that in any embodiment involving polyurethanes, polyureas, and polyurethane polyurea hybrid reactive systems, an amine functional molecule could be substituted for an alcohol functional molecule to modify the properties and cure speed, e.g. a polyamine could be substituted for a polyol.

In some embodiments, polyurethanes, polyureas, and polyurethane polyurea hybrid reactive systems involve the reaction of either an alcohol group and an isocyanate (e.g., to form a urethane bond), or an amine group and an isocyanate (e.g., to form a urea bond). In some embodiments, a formulated polyurethane elastomer system comprises: diiisocyanate molecules, e.g. methylene diphenyl diisocyanate (MDI), toluene diisocyanate (TDI), or hexamethylene diisocyanate (HDI); and a polyol, e.g. 1,4 butane diol. When the diisocyanate is blended with the polyol, the two may react and link together to form a long chain of alternating diisocyanate segments and polyol segments. The diisocyanate segments may be referred to as the hard segment because in some embodiments they readily hydrogen bond with one another to form physical cross-links across polymer chains. The polyol segments may be referred to as soft segments because in some embodiments they do not interact with one another, and can easily be elongated from a coiled conformation to an elongated conformation to provide stretchability. In some embodiments, the articles and methods described herein may be used in industrial applications. In some embodiments, the diisocyanate may be altered to improve processability and safety. For example, MDI, which under atmospheric pressure is solid at room temperature and forms a toxic vapor when heated, may be turned into isocyanate prepolymers. This process may involve chemically attaching diisocyanate molecules like MDI to both ends of a polyol molecule. This may effectively create high molecular weight disocyanate molecules that are usually liquid at room temperature, and are much safer to handle than pure MDI or other low molecular weight diisocyanates. The length of the polyol that is functionalized with the diisocyanate molecules may define the isocyanate group content percent (e.g., mole percent) of the prepolymer. In some embodiments, a low molecular weight polyol with MDI end caps will have a higher ratio of free isocyanate groups per volume than a high molecular weight polyol functionalized with the same MDI molecules. In some embodiments, it is possible to make prepolymer systems that are nearly 100% composed of polyol capped with isocyanates leaving nearly zero free unbound low molecular weight diisocyanate molecules. In some embodiments, systems are used that comprise a mixture of bound and unbound molecules. These systems are called quasi prepolymers.

In some embodiments, when working with an isocyanate prepolymer, or a quasi isocyanate prepolymer, the prepolymer may be liquid at the processing temperature. In some embodiments, a two-part formulation includes the prepolymer system, as manufactured, as one of the parts of the system, and a formulated polyol system as the second part of the system. As a non-limiting example, a very simple polyol system may include 1,4 butanediol, a very low molecular weight diol, and in some cases other additives. Non-limiting examples of additives include catalysts, thickeners, UV absorbers, antioxitants, pigments, molecular sieves, fillers, liquid rheology additives. In some embodiments, in the case of a very short diol like 1,4, butanediol, the prepolymers and free MDI molecules may end up being very closely spaced in the cured system, and a high ratio of the polymer chain may comprise hard isocyanate segments, because less total polymer mass may be required to react with all of the free isocyanate sites. As a result, the material may be generally more rigid than an identical prepolymer system that was blended with a higher molecular weight polyol system in which more polymer mass is required to react with all of the free isocyanate sites

In some embodiments, a polyol formulation for an elastomer may include any of the following polyols or any combination thereof: high molecular weight diol, low molecular weight diol (e.g., 1,4 butanediol; referred to as a chain extender), high and/or low molecular weight triol, and/or low molecular weight higher functionality of alcohol groups (e.g., functionality from 4 to 7 alcohol groups per molecule).

In some embodiments, the ratio of higher functionality polyols (e.g. triols) to diols defines the functionality of the system, or the degree of branching. In some embodiments, the ratios of all polyols in the polyol system mentioned herein, along with the level of fillers and other additives to the polyol system, and their densities, define the number of free alcohol groups per volume of polyol system. As will be known to those of ordinary skill in the art, in some embodiments, the number that describes the concentration of reactive groups is called the equivalent weight, or the equivalent weight of total material per reactive site. In some embodiments, this can be correlated to an equivalent volume using the density of the system. Similarly, the number of free isocyanate groups in the prepolymer system per volume can be calculated based on the isocyanate group content percent and density. When mixing the polyol system with the isocyanate prepolymer system, the volume ratio may be chosen such that for every free isocyanate group in the prepolymer system, there is a free alcohol group to react with it. For example, if a prepolymer formulation were used with an equivalent weight of 200, and a polyol formulation with an equivalent weight of 400, then for every 100 grams of prepolymer you would need to mix in 200 grams of polyol system to have an exactly stoichiometrically balanced system. In some cases, this ratio is shifted in one direction or the other, in order to over index or under index the isocyanate, depending on the application.

In some embodiments, even if the isocyanate prepolymer system is held fixed, the properties of the resulting formulation can be varied dramatically from a rigid thermoset, to a soft elastomer based on molecular weight. In some embodiments, the result can be changed from a thermoset (functionality >2) to a thermoplastic (functionality less than or equal to 2), based on the functionality of the polyol systems. In some embodiments, these systems may be used with herein described active mixing to produce zonal control of material characteristics.

In some embodiments, a 3D-printed material may be formed on an article disposed on a substrate that is configured to interact with a detection system in a manner that promotes alignment of the 3D-printed article (and/or portions thereof) with respect to the article disposed on the substrate and/or precision in the positioning of the 3D-printed article (and/or portions thereof) onto the article disposed on the substrate. For example, the article may comprise one or more features that may be detected by a detector. The detector may be in electronic communication (e.g., by use of a wired and/or wireless connection) with a print head configured to deposit a material onto the substrate and article disposed thereon, and/or may be configured to transmit information to the print head configured to deposit a material onto the substrate and article disposed thereon. In certain cases, the detector may be configured to detect information about the article disposed on the substrate, such as the location of the article (and/or a portion thereof) in space, with respect to the substrate, and/or with respect to the print head; the orientation of the article (and/or a portion thereof) in space, with respect to the substrate, and/or with respect to the print head; and/or one or more qualities associated with the article (e.g., the scale of the article, the skew of the article, the mirroring of the article, whether or not the article has undergone an affine transformation). The detector may send instructions to the print head and/or the substrate based on some or all of the information it detects. For example, the detector may detect that the article is located in an undesirable position, and may send an instruction to the substrate to translate and/or rotate so that the article is located in a desirable position. As a second example, the detector may detect that the article is located in a desirable position, and may send instructions to the print head to print onto the article and/or to translate and/or rotate to a desired position and then print onto the article. As a third example, the detector may detect that the article has undergone a certain amount of skew, and send instructions to the print head to modify its motion with respect to the article to account for the skew. Other types of instructions may also be sent.

When present, a detector configured to detect one of more features of an article disposed on a substrate may be located in any suitable position. The detector may be configured to be stationary (e.g., it may be mounted above the substrate at a fixed position), or may be configured to be translated and/or rotated (e.g., it may be mounted on a gantry on which one or more other features such as the print head may also be positioned). The detector may be configured to have a known position with respect to one or more other components of a deposition system (e.g., a print head, a substrate), and/or may be configured to detect its location with respect to one or more components of the deposition system (e.g., the print head, the substrate). For example, the detector may detect its position with respect to the print head by depositing a material onto the substrate (or an article disposed thereon) and detecting the location of the deposited material.

In some embodiments, a detector configured to detect a feature is an optical detector and an article disposed on a substrate comprises features that may be detected optically. For example, the features may be patterns printed onto an article disposed on the substrate, portions of an article disposed on a substrate that scatter light in a detectable manner, portions of an article disposed on a substrate that absorb light in a detectable manner, and/or portions of an article disposed on a substrate that reflect light in a detectable manner. Other types of features that may be detected optically are also contemplated. One example of a suitable type of optical detector is an optical camera.

In some embodiments, as also described elsewhere herein, an article disposed on a substrate may be a fabric, such as a knitted fabric or a woven fabric. The fabrics may comprise one or more features which include one or more portions that are knitted or woven to form a pattern that may be detectable optically. The feature(s) may either be created inline (e.g., during the knitting or weaving process used to form the fabric), or may be added to the fabric after it has been formed. In some embodiments, the feature(s) may comprise portion(s) of a pattern (e.g., a repeating motif) knitted or woven into the fabric or printed onto the fabric.

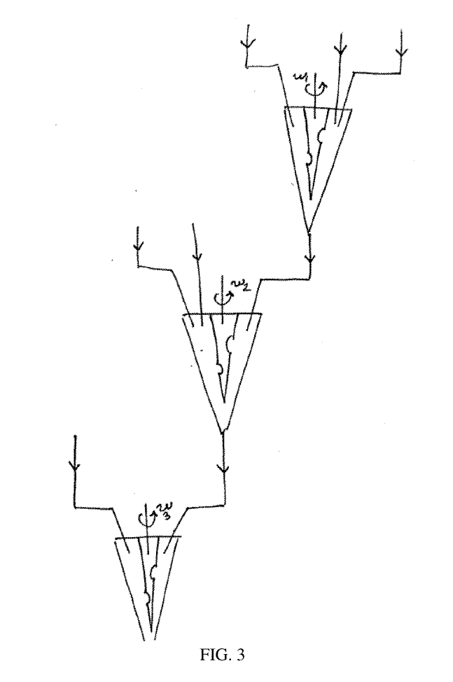

As mentioned, if more than two fluids or reactants are used, they may, in some embodiments, be introduced into the same nozzle, as is shown in FIG. 1. However, in other embodiments, one or more of the fluids or reactants may be mixed to form a mixture (for example, in a first mixing chamber), which can then be mixed with another fluid or reactant (e.g., in a nozzle such as discussed herein). A non-limiting example of a two-stage process is shown in FIG. 2. In this figure, system 10 includes a nozzle 15 and a mixing chamber 19. First nozzle 15 may be a nozzle such as discussed above with respect to FIG. 1. For instance, first nozzle 15 may contain an impeller 20, an outlet 18, and have one, two, or more inputs, e.g., inputs 31 and 35 as shown in this figure.

In some cases, one or more of the inputs to first nozzle 15 may be a mixing chamber, such as mixing chamber 19, having an output 38 which fluidly communicates to inlet 35 of nozzle 15 in this figure. In some cases, mixing chamber may have a similar shape to nozzle 15 (e.g., mixing chamber 19 may be a nozzle), although this is not a requirement. Mixing chamber may have, in some embodiments, one or more inputs (e.g., inputs 41 and 42). In addition, in some cases, mixing nozzle 19 may include an impeller 29, or another suitable mixing apparatus. In this example, impeller 29 causes mixing via spinning (depicted in FIG. 1 as arrow 26). The mixing may be active or passive, and may be the same or different as in nozzle 15. In some cases, even more stages may be used, in series and/or parallel, to provide material for input into a nozzle. For instance, a non-limiting example of a 3-stage serial process can be seen in FIG. 3. In addition, in some cases, partial or no mixing of fluids may occur within mixing chamber 19, e.g., the fluids may be brought into contact, and some partial or incidental mixing may occur, while more vigorous mixing may occur within first nozzle 15.

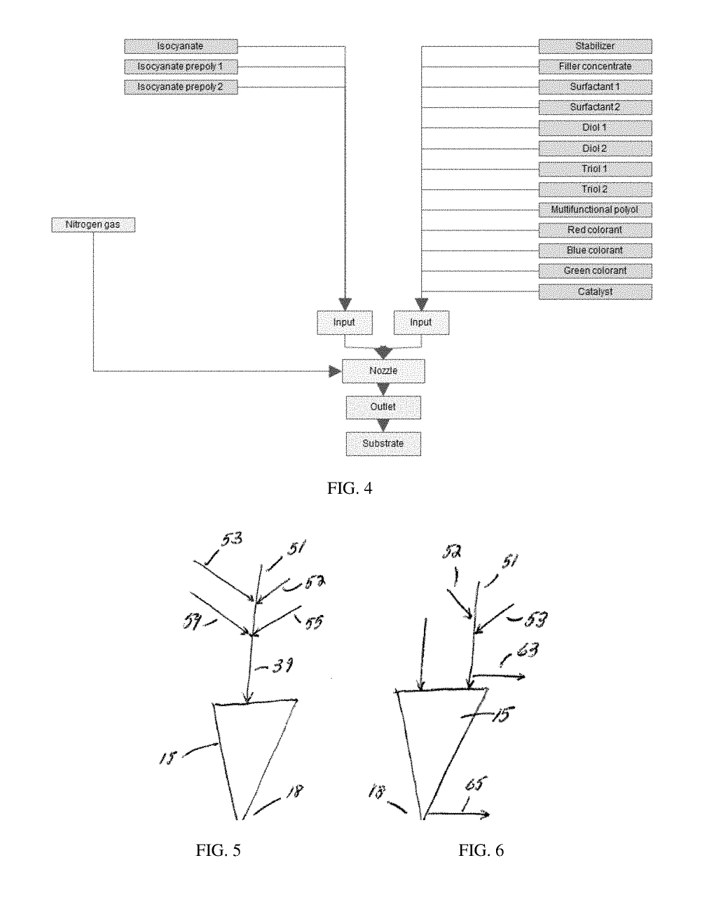

A more specific example is provided in FIG. 4. In this figure, three inputs are provided to a nozzle, e.g., to a mixing chamber of a nozzle. These inputs are provided by way of illustration only, and may vary in different embodiments of the invention. In this figure, a first input may be one or more of a variety of isocyanates, while a second input may include any one or more of a variety of inputs, including stabilizers, filler concentrate, surfactants, diols, triols, multifunctional polyols, colorants, catalysts, etc. These may be provided as inputs to a nozzle, in which mixing occurs, as shown in this figure. In some cases, a cell-forming agent, such as a gas or a blowing agent, may also be added, and these may be substantially homogenously mixed together. In some cases, these may form a foam or froth, e.g., comprising a plurality of relatively small bubbles of gas dispersed within a material, e.g., substantially uniformly distributed. This may then be deposited through the outlet onto a substrate, e.g., controlled by a controller, which may control deposition using a valve or other suitable apparatus.

The above discussion describes certain non-limiting examples of various embodiments of the present invention that can be used to produce 3-dimensionally printed foams and other products, as well as articles made using such techniques. However, other embodiments are also possible. Accordingly, more generally, various aspects of the invention are directed to various systems and methods for 3D-printing foams and other objects as described herein.

In certain embodiments, an article (e.g., an article of footwear, a component of an article of footwear, an article of apparel such as a sports bra, a component of an article of apparel such as a sports bra) as described herein may be produced on a multi-axis deposition system, and/or a method as described herein may include at least one step that is performed on a multi-axis deposition system. In general, and as described further below, multi-axis deposition systems include a print head and a substrate. The print head may be any suitable print head configured to deposit a material onto the substrate. The substrate may be any suitable substrate onto which a material may be deposited; in some embodiments, one or more articles (e.g., a component of an article of footwear, an upper, a sock liner) may be disposed on the substrate. In certain embodiments, one or both of the print head and substrate may be translated along one or more axes and/or rotated around one or more axes. Translation and/or rotation of the print head and/or substrate may enable the position of the print head with respect to the substrate to be changed prior to, during, and/or after a printing process. In some cases, translation and/or rotation of the print head and/or the substrate may allow the print head to deposit material onto a wide variety of substrate surfaces and/or allow the print head to deposit material onto the substrate at a wide variety of angles. In some embodiments, the print head may be configured to be rotated and/or translated such that it can deposit material onto each surface of the substrate.

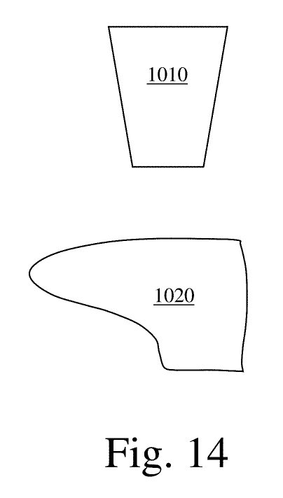

FIG. 14 shows one non-limiting embodiment of a multi-axis deposition system 1000 comprising print head 1010 and substrate 1020. The print head, substrate, and multi-axis deposition system will be described in further detail below.

A print head in a multi-axis deposition system may be any suitable print head configured to deposit a material of interest onto the substrate. In some embodiments a multi-axis deposition system may comprise two or more print heads. Non-limiting examples of suitable print heads include a direct write head, a mixing nozzle, an ink jet head, a spray valve, an aerosol jet print head, a laser cutting head, a hot air gun, a hot knife, an ultrasonic knife, a sanding head, a polishing head, a UV curing device, an engraver, an embosser, and the like. In some embodiments, it may be advantageous for the multi-axis deposition system to comprise a first print head that is comprises a mixing nozzle and a second print head that does not comprise a mixing nozzle. As described elsewhere herein, in some embodiments, the print head may be configured to accept one or more material inputs (e.g., one material input, two material inputs, etc.). When two or more material inputs are present, the inputs may be substantially the same or they may differ. In some embodiments, the print head may be configured to mix two or more reactive material inputs to form a reactive mixture that may be deposited onto a substrate while the first and second material inputs are reacting and/or after the first and second material inputs have reacted. For example, the print head may be configured to mix a polyol and an isocyanate to form a reactive polyurethane mixture. Other examples of suitable reactive mixtures include reactive polyurea mixtures, reactive mixtures comprising reactive polyurethane and reactive polyurea blends, reactive mixtures comprising epoxy groups and amine groups, and reactive silicone mixtures.

A substrate in a multi-axis deposition system may be any suitable substrate capable of receiving the material deposited by the print head. In some cases, the substrate may have a shape that enables facile deposition of the material of interest in a morphology of interest by the print head. As an example, the substrate may have a shape that substantially corresponds to the morphology of interest, such as a footwear last for footwear applications (e.g., as shown in FIG. 14), a bra cup for sports bra applications and/or for bra lining applications, an article substantially corresponding to the shape of a knee for knee brace applications, an article substantially corresponding to the shape of an ankle for ankle brace applications, an article substantially corresponding to the shape of a wrist for wrist brace applications, an article substantially corresponding to the shape of a shoulder for shoulder brace applications, and/or an article substantially corresponding to the shape of an arm for arm band applications. As another example, the substrate may be a mold or a portion of a mold. As a third example, the substrate may comprise a portion that is curved, and/or the substrate as a whole be curved. For instance, the substrate may have a spherical shape, or a hemispherical shape. As a fourth example, the substrate may comprise two or more surfaces that are joined at facets. In some such cases, the substrate may be a platonic solid or may comprise a portion that is a platonic solid. In some embodiments, the substrate may be substantially flat. Other types of substrates are also possible.

In some embodiments, a multi-axis deposition system may comprise a substrate that is removable. The substrate may be configured to be positioned in the multi-axis deposition system during material deposition and removed after material deposition. In some embodiments, a multi-axis deposition system may comprise multiple substrates that may be added to the multi-axis deposition system prior to material deposition and/or removed from the multi-axis deposition system after material deposition. Each substrate may have a different shape (e.g., a different shoe size, a different cup size, a mold for a different type of apparel), or two or more substrates may have substantially the same shape.

As described above, one or more articles may be disposed on the substrate prior to material deposition and/or during material deposition using a multi-axis deposition system. The article(s) disposed on the substrate may be configured to be positioned on the substrate during material deposition and, optionally, removed from the substrate after material deposition. In some embodiments, a multi-axis deposition system may be configured to deposit material onto a multiple articles successively, each of which may be added to the multi-axis deposition system prior to material deposition and/or removed from the multi-axis deposition system after material deposition. For example, a textile (e.g., a non-flat textile, an upper, a woven textile, a knit textile) may be disposed on the substrate prior to material deposition, during material deposition, and/or after material deposition. In some embodiments, a multi-axis deposition system may be employed to deposit a reactive mixture as described above onto a textile to form a 3D-printed material on the textile and/or on a succession of textiles sequentially added to the substrate.

It should be noted that the print head(s) and the substrate in a multi-axis deposition system comprising both a print head and a substrate may be oriented with respect to each other in other ways than that shown in FIG. 14. As an example, a print head may be disposed over the center of the substrate in some embodiments and over the edge of the substrate in other embodiments. As another example, a print head may be oriented so that it deposits material on the substrate at a 90° angle to the substrate in some embodiments and so that it deposits material on the substrate at another angle to the substrate (e.g., 45°, 30°, or other angles) in other embodiments. As a third example, the substrate may present a bottom surface (e.g., a portion of a last on which a sole would be disposed) to a print head in some embodiments and may present a side or top surface (e.g., a portion of a last on which an upper would be disposed) in other embodiments. In some cases, the print head(s) and/or the substrate may be configured to be translated and/or rotated around one or more axes, as described further below. In such cases, the absolute positions of the print head(s) and the substrate may be varied during operation of the multi-axis system, and/or the relative position of the print head(s) with respect to the substrate may be varied during operation of the multi-axis system.

As described above, a multi-axis deposition system may comprise one or more print heads that may be configured to be translated along one or more axes. In some embodiments, one or more print heads may be configured to be translated along one axis, along two axes, or along three axes. In certain cases, the axes may be perpendicular to each other. In other cases two or more of the axes are not perpendicular to each other (e.g., they may intersect at an angle between 45° and 90°). For example, in some embodiments the print head may be configured to be translated vertically, and/or translated in one or more directions perpendicular to the vertical direction. As another example, in some embodiments one or more print heads may be configured to be translated in a direction perpendicular to the substrate, and/or in one or more directions parallel to the substrate. As a third example, in some embodiments one or more print heads may be configured to be translated at a 45° angle with respect to the substrate. In some cases, each axis of translation may independently be controlled by separate motors. In some embodiments, one or more print heads may not be configured to be translated.

In some embodiments, one or more print heads in a multi-axis system may be configured to be rotated around one axis, around two axes, or around three axes. In some embodiments, one or more print heads may be configured to be rotated around more than three axes (e.g., around more than four axes, around more than six axes, around more than eight axes, around more than 10 axes, or around more than 12 axes). In certain cases, the axes may be perpendicular to each other. For example, in some embodiments the print head may be configured to be rotated around a vertical axis, and/or rotated around one or more axes perpendicular to the vertical axis. As another example, in some embodiments one or more print heads may be configured to be rotated around an axis perpendicular to the substrate, and/or around one or more axes parallel to the substrate. In some cases, each axis of rotation may independently be controlled by separate motors. In some embodiments, one or more print heads may not be configured to be rotated. In some embodiments, the print head may be configured to be stationary.

In some embodiments, a substrate in a multi-axis system may be configured to be translated along one axis, along two axes, or along three axes. In certain cases, the axes may be perpendicular to each other. In other cases two or more of the axes are perpendicular to each other (e.g., they may intersect at an angle between 45° and 90°). For example, in some embodiments the substrate may be configured to be translated vertically, and/or translated in one or more directions perpendicular to the vertical direction. As another example, in some embodiments the substrate may be configured to be translated in a direction perpendicular to the print head, and/or in one or more directions parallel to the print head. As a third example, in some embodiments the print head may be configured to be translated at a 45° angle with respect to the substrate. In some cases, each axis of translation may independently be controlled by separate motors. In some embodiments, the substrate may not be configured to be translated.

In some embodiments, a substrate in a multi-axis system may be configured to be rotated around one axis, around two axes, or around three axes. In certain cases, the axes may be perpendicular to each other. In some embodiments, the substrate may be configured to be rotated around more than three axes (e.g., around more than four axes, around more than six axes, around more than eight axes, around more than 10 axes, or around more than 12 axes). For example, in some embodiments the substrate may be configured to be rotated around a vertical axis, and/or rotated around one or more axes perpendicular to the vertical axis. As another example, in some embodiments the substrate may be configured to be rotated around an axis perpendicular to the print head, and/or around one or more axes parallel to the print head. In some cases, each axis of rotation may independently be controlled by separate motors. In some embodiments, the substrate may not be configured to be rotated. In some embodiments, the substrate may be configured to be stationary.

In some embodiments, a multi-axis deposition system may comprise one or more features that aid rotation and/or translation of a print head and/or a substrate. As an example, in some cases the print head may be attached to a print head arm that facilitates motion. When two or more print heads are present, each print head may be positioned separate print head arms or two or more print heads may be positioned on the same print head arm. In some cases, two or more print head arms may be attached to a single gantry. The print head arms may be capable of facilitating translation and/or rotation of the print head. In some embodiments, the print head(s) may be attached to single print head arms; in other embodiments, the print head(s) may be attached to multiple print head arms that are attached at joints that allow for rotation and/or translation. In some cases, one or more motors may facilitate motion of one or more components of the print head arm(s). As another example, in some cases the substrate may be attached to a substrate arm that facilitates motion. The substrate arm may be capable of facilitating translation and/or rotation of the substrate. In some embodiments, the substrate may be attached to a single substrate arm; in other embodiments, the substrate may be attached to multiple substrate arms that are attached at joints that allow for rotation and/or translation. In some cases, the substrate may be attached to a robot arm. In some cases, one or more motors may facilitate motion of one or more components of the substrate arm(s). In certain embodiments, the print head may be attached to a print head arm and the substrate may be attached to a substrate arm.

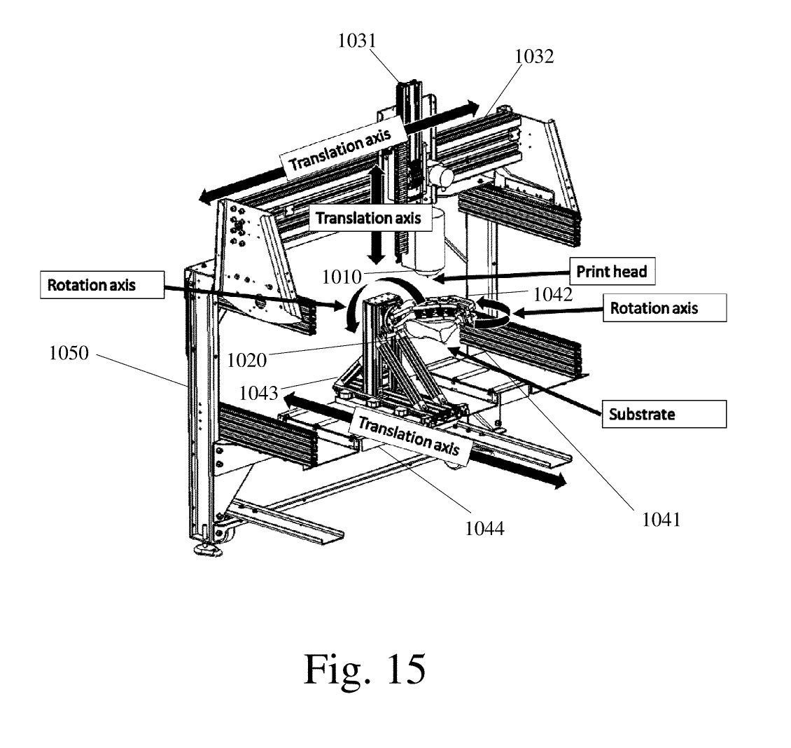

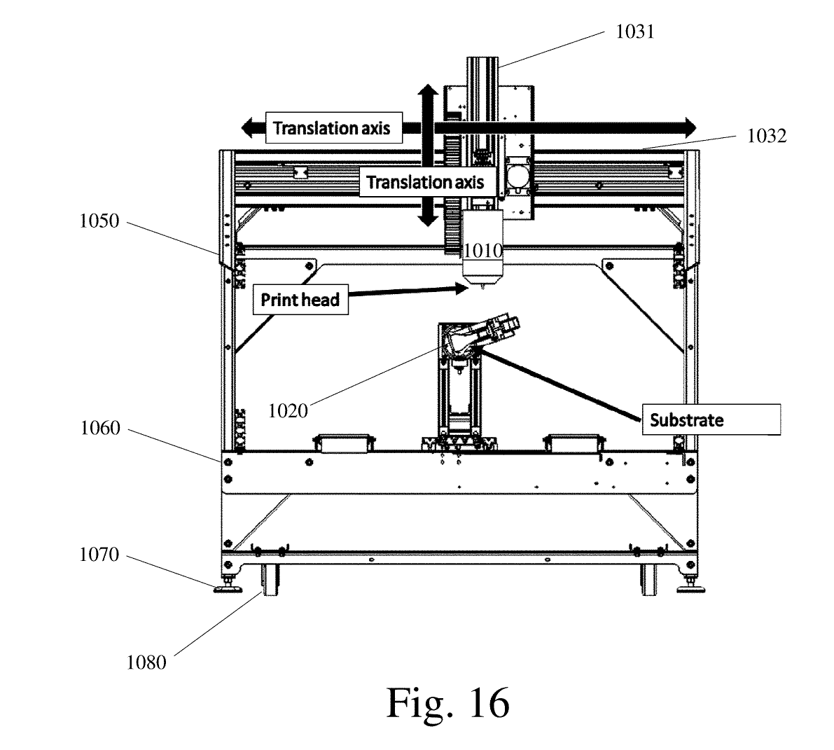

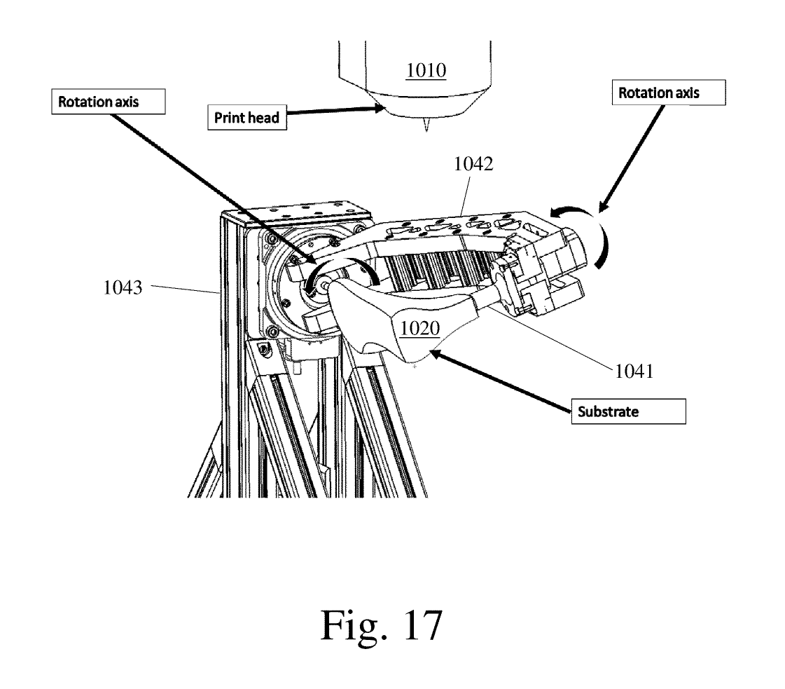

FIGS. 15-17 show various views of a non-limiting embodiment of a multi-axis deposition system showing various combinations of axes around which a print head and substrate therein may be configured to be rotated and/or translated. FIG. 15 shows a perspective view of the system as a whole, FIG. 16 shows a cross-sectional view of the system as a whole, and FIG. 17 shows a close up perspective view of the print head and the substrate. It should be understood that these figures do not show all possible combinations of print head and substrate motion, and that all combinations of print head motion and substrate motion described above are contemplated.

In FIGS. 15-17, the multi-axis deposition system includes print head 1010 and substrate 1020. Print head 1010 in FIGS. 15-17 is attached to first print head arm 1031, which is attached to second print head arm 1032 by a first print head joint configured to allow translation of first print head arm 1031 along a first print head translation axis and along a second print head translation axis. Second print head arm 1032 is also attached to gantry 1050, which supports the second print head arm. In some embodiments, the second print head arm is attached to the gantry by screws and held in a stationary position (as is shown in FIGS. 15-17). In other embodiments, the second print head arm is configured to be translated along one or more axes and/or rotated around one or more axes. The print head may be translated along the first print head translation axis by translating the first print head arm along the first print head translation axis, and the print head may be translated along the second print head translation axis by translating the first print head arm along the second print head translation axis. In certain cases, such as that shown in FIGS. 15-17, the second print head arm may be a track along which the first print head arm may be translated and/or the first print head joint may comprise a track along which the first print head arm may be translated. In other embodiments, other types of joints and print head arms may be employed.

Substrate 1010 in FIGS. 15-17 is attached to first substrate arm 1041, which is attached to second substrate arm 1042 by a first substrate joint configured to allow rotation of first substrate arm 1041 around a first substrate rotation axis. Second substrate arm 1042 is attached to third substrate arm 1043 by a second substrate joint configured to allow rotation of second substrate arm 1042 around a second substrate rotation axis. The substrate may be rotated around the first substrate rotation axis by rotating the first substrate arm around the first substrate rotation axis, and around the second substrate rotation axis by rotating the second substrate arm around the second substrate rotation axis. In some embodiments, one or more of the substrate arms may curved (e.g., second substrate arm as shown in FIGS. 15-17). Third substrate arm 1043 is attached to support 1044 by a third substrate joint configured to allow translation of the third arm along a first substrate translation axis. The substrate may be translated along the first substrate translation axis by translating the third arm along the first substrate translation axis. In certain cases, such as that shown in FIGS. 15-17, the third substrate arm may be a track along which the second substrate arm may be translated. In other embodiments, other types substrate arms may be employed.

In some embodiments, a multi-axis system may comprise further features in addition to some or all of those described above. For example, the multi-axis system may be encased in a frame or enclosure. FIG. 16 includes frame 1060 with feet 1070 and wheels 1080. The feet may aid stable positioning of the frame on a surface (e.g., a floor, a desktop, a lab bench). The wheels may promote facile repositioning of the frame in different locations. In some embodiments, one or more components (e.g., the frame, one or more arms) may be formed from standardized parts, such as T-slotted framing. Other types of standardized parts, and/or non-standard parts, may also be employed.

Certain combinations of print head motion and substrate motion may be especially advantageous. For example, as shown in FIGS. 15-17, a print head may be configured to be translated vertically and in a first horizontal direction, and the substrate may be configured to be translated along a second horizontal direction perpendicular to the first horizontal direction and rotated around two distinct axes. As another example, a print head may be configured to be translated in three perpendicular directions and the substrate may be configured to be rotated around two distinct axes. As a third example, a print head may be configured to be stationary and the substrate may be configured to be translated in three perpendicular directions and rotated around two distinct axes. As a fourth example, a print head may be configured to be translated around three distinct rotation axes and along three distinct translation axes, and the substrate may be configured to be stationary. Other combinations of print head motion and substrate motion are also possible.

In some embodiments, a multi-axis system may have one or more features that make it suitable for 3D-printing materials of interest. For example, the multi-axis system may be configured to deposit a material onto a substrate as a continuous stream or as a continuous filament. In other words, the substrate may be in fluid communication with the print head via the material during deposition. In certain cases, the multi-axis system may be employed to deposit a continuous stream or filament that extends from a first side of a last or a material disposed on the last (e.g., an upper, a 3D-printed material disposed on an upper) across the bottom of the last or material disposed on the last to the opposing side of the last or material disposed on the last. In some cases, the multi-axis system may be employed to print each portion of an article of footwear except for the upper.

In some embodiments, a multi-axis system may be configured to 3D-print materials with one or more advantageous properties. For example, the multi-axis system may be configured to 3D-print materials with a feature size of greater than or equal to 100 microns, greater than or equal to 200 microns, greater than or equal to 500 microns, greater than or equal to 1 mm, greater than or equal to 2 mm, greater than or equal to 5 mm, greater than or equal to 10 mm, greater than or equal to 20 mm, greater than or equal to 50 mm, greater than or equal to 1 cm, or greater than or equal to 2 cm. In some embodiments, the multi-axis system may be configured to 3D-print materials with a feature size of less than or equal to 5 cm, less than or equal to 2 cm, less than or equal to 1 cm, less than or equal to 5 mm, less than or equal to 2 mm, less than or equal to 1 mm, less than or equal to 500 microns, or less than or equal to 200 microns. Combinations of the above-referenced ranges are also possible (e.g., greater than or equal to 100 microns and less than or equal to 5 cm). Other ranges are also possible.

As discussed herein, a 3D printer may be provided that is capable of printing a material (e.g., a polymeric material, a composite) that is formed by combing two or more other materials (e.g., a polymer and particles e.g. reinforcing particles, a polymer and a filler) to create a 3D object, such as an article of a shoe. Additionally (or alternatively), such 3D objects may comprise a gradient structure with at least one non-uniform property (e.g., color, average stiffness, average Shore A hardness, average pore size, and average density). The inventors have appreciated that existing techniques for generating printer instructions for a 3D printer, such as those implemented in conventional slicer software applications, may be unable to accurately determine appropriate printer settings (e.g., a ratio of two or more inputs to a mixing chamber and/or nozzle, a spin speed of an impeller in the mixing nozzle, sequencing of material into a mixing chamber and/or nozzle, and valving to change material inputs into the mixing chamber and/or nozzle) to properly print such materials. Accordingly, aspects of the present disclosure relate to a computer program that is configured to generate printer settings for printing such materials in uniform and/or gradient structures of a 3D object.

The computer program may be configured to receive object information, such as a design file for a 3D object (e.g., from a computer-aided design (CAD) program) and/or a print path for printing a 3D object (e.g., from a slicer application) with information indicative of target material properties at various points along the print path, and output print instructions that may be provided to a 3D printer to accurately create the 3D object. The computer program may generate the print instructions by, for example, identifying a target material that is to be deposited, identifying the input materials required to create the target material, and identifying the printer settings to print the target material using the input materials. Once the appropriate set of printer settings have been identified, print instructions may be generated using the identified set of printer settings. For example, print instructions may be generated that comprise a print path for the print head to follow and printer settings information indicative of the appropriate printer settings at a plurality of points along the print path.

The computer program may comprise a set of instructions that may be executed by a computer system comprising a processor (e.g., a hardware processor or a virtual processor) and a memory (e.g., a non-transitory computer readable medium). For example, the computer program may comprise a set of instructions stored in a non-transitory computer readable medium that programs at least one processor coupled to the non-transitory computer readable medium. It should be appreciated that the computer system may be communicatively coupled to a 3D printer and/or integrated with the 3D printer.

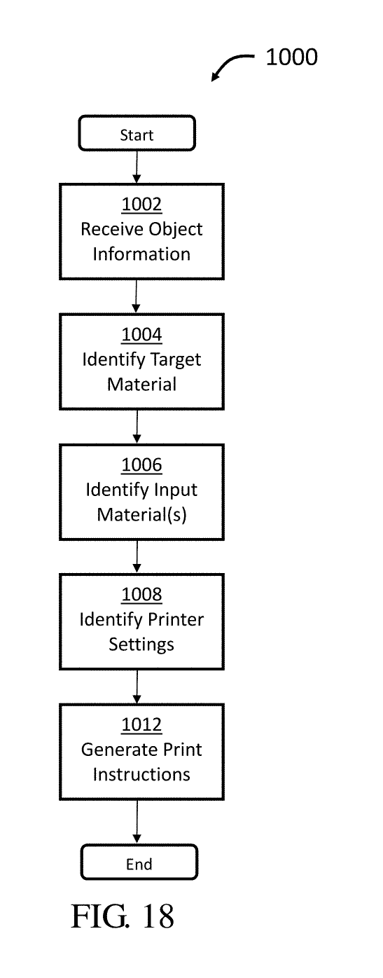

In some embodiments, the computer program may comprise a plurality of instructions that program at least one processor to perform a method 1000 in FIG. 18. As shown, the method 1000 comprises an act 1002 of receiving object information, an act 1004 of identifying target material to be printed, an act 1006 of identifying input materials to form the target material, an act 1008 of identifying printer settings to print the target material, and an act 1012 of generating print instructions.

In act 1002, the system may receive object information associated with a 3D object. The object information may be, for example, a design file for a 3D object to be printed. The design file may comprise information indicative of one or more properties of the 3D object such as shape, material composition, and/or color. The design file may be in any of a variety of formats. Example formats include: Drawing Interchange Format (DXF), COLLAborative Design Activity (COLLADA), STereoLithography (STL), Initial Graphics Exchange Specification (IGES), and Virtual Reality Modeling Language (VRML). Alternatively (or additionally), the object information may comprise a print path for a print head to follow to print the 3D object (e.g., generated by a slicer application) and information indicative of the desired material properties at various points along the print path. For example, the object information may comprise a print path comprising a plurality of points and metadata associated with one or more (or all of) the plurality of points indicative of a desired material property at the point (e.g., color, average stiffness, average Shore A hardness, average pore size, average density, etc.). In some implementations, the metadata may be directly associated with one or more points in the plurality of points. In other implementations, the metadata may be stored in another format and overlaid onto the print path to determine the material properties at a given point. For example, the metadata may be desired color information stored in an image comprising a plurality of pixel values that may be overlaid onto the print path. In this example, the pixel value that aligns with a given point in the print path may be the metadata associated with the respective point.

In act 1004, the system may identify a target material to be printed based on the object information. For example, the object information may comprise information regarding the target material (e.g., in metadata) and the system may directly identify the target material from the received object information.

In act 1006, the system may identify input material(s) to create the target material. For example, the 3D printer may print the target material in the object by mixing a first material with a second material. In this example, the system may identify the first and second materials. The system may identify this information by, for example, retrieving information stored in a memory of the computer system regarding the input materials required to create the target material in the object.

In act 1008, the system identifies one or more printer settings for printing the target material using the identified input materials. In some embodiments, the system may identify one or more printer settings required to print the target material at a plurality of discrete points in the object (e.g., along the print path). In instances where the printer settings deviate between discrete points (e.g., to print a gradient structure in the object), the system may employ interpolation techniques (e.g., linear interpolation and cubic interpolation) to smooth shifts in printer settings between the discrete points. In one example for illustration, the system may identify that the mixing ratio of two materials needs to be 40/60 at a first point in a gradient structure and a 50/50 ratio at a second point in the gradient structure. In this example, the system may fit a linear curve between the first and second points to create a smooth ramp between a 40/60 ratio and a 50/50 ratio. Thereby, the system may create a set of printer settings to employ along the print path as the print head moves from the first point to the second point.

In act 1012, the system may generate the print instructions using the identified printer settings in act 1008. The print instructions may comprise, for example, a print path for a print head to follow to print the 3D object along with printer settings at a plurality of points along the print path (e.g., generated in act 1008). The print instructions may be, for example, G-code instructions. Once the print instructions have been generated, the system may transmit the print instructions to a 3D printer (and/or one or more other components of a 3D printer in embodiments where the computer system is integrated with the 3D printer).

As mentioned, certain aspects of the invention are generally directed to foams. Such foams may be used in a variety of applications, such as footwear. The foam may be a material comprising a matrix and pores disposed within the matrix. Pores may be randomly distributed throughout the foam, or may be positioned at regular and/or pre-determined intervals. The material present within the pores of a foam is typically of a different phase than the material forming the matrix of the foam (e.g., a foam may comprise pores that comprise gas within a matrix that comprises a liquid and/or a solid). As would be understood to one of ordinary skill in the art, in a closed-cell foam, the cells of the foam are typically isolated or separated from each other. By contrast, in an open-cell foam, the cells of the foam are interconnected with each other; for example, they may be formed in an interconnected fashion, or the cells may be ruptured or become interconnected during or after formation of the foam. These conditions are typically more violent foaming conditions than those resulting in a closed-cell foam.

The foam may be formed from a variety of polymers and gases. The gases may be introduced into materials to form the foam in a number of ways, including into the foam components prior to entrance into the mixing nozzle (e.g. frothed components), during the mixing of components (e.g., active frothing), upon exiting the print nozzle (e.g. release of pressure or spike in temperature to generate gas), generated during printing (e.g. water-blown polyurethanes), generated in a post process after printing is complete by thermally, or otherwise, activating a chemical additive within the material (e.g. blowing agent), etc. In addition, in some cases, a gas may be introduced by providing a liquid that forms a gas, e.g., upon a decrease in pressure or an increase in temperature. For instance, a liquid such as butane may be kept under pressure and/or cooled prior to introduction into the nozzle or the mixing chamber; a change in temperature and/or pressure may cause the liquid to form a gas. Without wishing to be bound by theory, closed cell foams and open cell foams may have different properties (e.g., closed cell foams may have different values of density, stiffness, hardness, and the like than otherwise equivalent open cell foams) and may be suitable for different applications. In some embodiments, closed cell foams may have properties that are better suited to footwear applications than open cell foams.

In some cases, the foams may be prepared to be lightweight, tough, elastic, and/or soft, e.g., using techniques such as those discussed herein. For example, polyurethane foams can be made into a variety of different applications such as shoe soles, cushions, pads, insulation, etc. The properties of the foam can be varied widely, as discussed herein. As an example, similar raw materials can be used to create a piece of rigid insulation, a memory foam pillow, a low density elastic foam pad for a seat cushion, or a high density foam outsole of a shoe. Further non-limiting examples of 3D printed shoes may be seen in a U.S. provisional patent application filed on Feb. 27, 2017, entitled “Systems and Methods for Three-Dimensional Printing of Footwear and Other Articles,” incorporated herein by reference in its entirety.

In some cases, foams may be prepared as discussed herein using various inputs and mixing the inputs using an active mixing nozzle, as described herein. For instance, the foam density may be varied by varying the amount of added gas, the amount of added water (e.g., in water-blown foam applications), the amount of added blowing agent, etc. As another example, the foam density constant may be held constant, but the cross-link density or isocyanate content may be varied to change properties such as the elasticity, elongation, or stiffness of the foam.

In some cases, as discussed herein, a foam precursor, prior to curing, may have different rheological properties than the starting raw materials without gas content. For example, a mixture of low viscosity fluids, gases, and/or surfactants, etc. having Newtonian flow behavior before foaming can be used to produce a precursor having non-Newtonian flow characteristics, e.g., with a yield stress, or shear-thickening or shear-thinning behavior. This may be used herein to produce a precursor having a rheological profile suitable for printing, e.g., on a substrate. Fluids such as incompressible Newtonian fluids or gases can be introduced into a nozzle (e.g., prior to mixing) in a controlled fashion and precisely metered onto a substrate during deposition. In some cases, the foaming process may start within the nozzle, and this process may affect the final mechanical properties of the foam.

Accordingly, certain aspects are generally directed to systems and methods for producing a foam or other products as discussed herein. In some cases, a foam may include a plurality of cells (which may include open and/or closed cells) within a polymer or other suitable matrix. Accordingly, certain embodiments described herein are directed to systems and methods able to 3D-print a material on a substrate that is able to form a foam. For instance, the material, at 3D-printing, may have properties that allow it to flow, e.g., from a nozzle, onto a substrate. The material may also contain a gas therein (and/or a gas precursor) that can form the cells of the foam, e.g., upon solidification of the material to form the foam. In some embodiments, a nozzle outlet may be surrounded by a compressed gas sheath. The compressed sheath may guide a gas stream to intersect with the outlet of the nozzle. The gas stream may be configured to atomize a material (e.g., a mixture) that exits (e.g., is extruded from) the nozzle. The atomized material (e.g., mixture) may be ejected towards the substrate. The atomized material (e.g., mixture) may land on the substrate such that it forms a film of material. The atomized material (e.g., mixture) may react to form a foam during and/or after deposition onto the substrate.

In some embodiments of the invention, a material is formed via mixing of two, three, or more fluids to form a precursor, which is 3D-printed onto a substrate and allowed to solidify to form a foam or other product, such as a thermoplastic, an elastomer, a rigid thermoset, or the like. A variety of fluids may be reacted to form a precursor to the foam, as is discussed in further detail herein. In some embodiments, a microfluidic printing nozzle is used to prepare the material prior to deposition onto a substrate. In some embodiments, more than one fluid may be introduced into the nozzle, and the fluids can be mixed within the nozzle to produce the material to be deposited onto the substrate.

In one set of embodiments, a nozzle is used to direct a material (e.g., a precursor) onto a substrate. The nozzle can have any suitable shape. The nozzle may have any suitable shape having an outlet able to direct material at a substrate. For instance, the nozzle may be conical, pyramid-shaped, funnel-shaped, cylindrical, or the like. The nozzle may also have any suitable size. In some cases, the nozzle may include one or more mixing chambers or other regions in which two fluids come into contact with each other, and can be mixed together, e.g., actively or passively. The nozzle or the mixing chamber may have a volume that is less than 20 ml, less than 18 ml, less than 16 ml, less than 14 ml, less than 12 ml, less than 10 ml, less than 8 ml, less than 6 ml, less than 5 ml, less than 4 ml, less than 3 ml, less than 2 ml, less than 1 ml, less than 0.5 ml, less than 0.3 ml, less than 0.1 ml, etc., and/or a volume that is at least 0.1 ml, at least 0.3 ml, at least 0.5 ml, at least 1 ml, at least 2 ml, at least 3 ml, at least 4 ml, at least 5 ml, at least 6 ml, at least 8 ml, at least 10 ml, at least 12 ml, at least 14 ml, at least 16 ml, at least 18 ml, at least 20 ml, etc.

In addition, fluids may be introduced into the nozzle, and product produced within the nozzle, at relatively high rates. For example, in certain embodiments, the rate of printing of product may be at least 0.1 mL/min, at least 0.3 mL/min, at least 0.5 mL/min, at least 1 mL/min, at least 3 mL/min, at least 5 mL/min, at least 10 mL/min, at least 30 mL/min, at least 50 mL/min, at least 100 mL/min, at least 300 mL/min, at least 500 mL/min, at least 1 L/min, at least 3 L/min, at least 5 L/min, at least 10 L/min, or at least 20 L/min. In some cases, the rate of printing may be no more than 25 L/min, no more than 20 L/min, no more than 15 L/min, no more than 10 L/min, no more than 5 L/min, no more than 3 L/min, no more than 1 L/min, no more than 500 mL/min, no more than 300 mL/min, no more than 100 mL/min, no more than 50 mL/min, no more than 30 mL/min, no more than 10 mL/min, no more than 5 mL/min, no more than 3 mL/min, no more than 1 mL/min, no more than 0.5 mL/min, no more than 0.3 mL/min, or no more than 0.1 mL/min. Combinations of any these are also possible, e.g., the rate of printing may be between 0.1 mL/min and 20 mL/min.

Relatively small volumes such as these may be useful in certain embodiments to promote more complete mixing, e.g., such that the fluids are substantially mixed together, and/or to promote smaller residence times within the mixer, for example, less than 30 s, less than 25 s, less than 20 s, less than 15 s, less than 10 s, or less than 5 s. In addition, relatively small volumes may be useful to more rapidly stop and/or alter the reactants (and/or additives, if present) within the nozzle or mixing chamber. In some instances, a smaller volume may be easier to control and/or alter the degree of mixing, e.g., to compensate for variable flowrates and system reactivities, or the like.

As mentioned, in certain embodiments of the invention, the nozzle may include a valve, such as a needle valve. In some cases, a valving system may be used to control fluid input into the nozzle and/or material exiting the nozzle. In certain instances, various components of the mixing system that come in contact with the material may be set up with a valving system.

The fluids may be mixed until they are substantially mixed together in certain embodiments, e.g., having a relatively uniform appearance, or are substantially homogenous mixed. For instance, the fluids may be mixed such that the individual fluids are evenly distributed relative to each other (e.g., upon exiting the nozzle). In some cases, after mixing, portions of the exiting mixture do not exhibit large or changing variations in relative distributions or ratios of one fluid relative to other fluids. However, in other cases, the fluids may only be partially mixed together. In some cases, mixing within the nozzle may be passive, e.g., where the flow of fluids into the nozzle causes the mixing of the fluids within the nozzle. The nozzle may also contain, in some embodiments, baffles or other impediments to disrupt the flow of fluid, e.g., to promote mixing.

As one non-limiting example, the geometry of the nozzle can be determined in certain embodiments for a given material set and flow rate such that the material exits the nozzle with a viscosity higher than the viscosities of any of the individual inputs but has not yet solidified. For instance, various polyols and the isocyanates can be selected to tune the material reactivity to suit the flow rate into the nozzle and the mixing volume, such that the materials begin to react as they are mixed and also remain fluid enough to be able to leave the nozzle at the outlet continuously. Other parameters, such as a catalyst or the temperature, may also be used to tune material reactivity. Non-limiting examples of methods of heating or cooling a nozzle are discussed in more detail below.

In some embodiments, material exiting the nozzle may pass through an opening which structures the printed line (e.g. continuously printing) or dose (e.g. dosing mode). The opening can be one of a variety of geometries including, but not limited to, circular, rectangular, star-shaped, any closed two-dimensional shape, multiple separate shapes (e.g., being fed from the same nozzle), or the like.

In addition, in some embodiments, the nozzle, mixing chamber, and/or the impeller may be at least partially coated with a non-stick surface to prevent material from building up on such surfaces. Examples of suitable coatings include, but are not limited to, polymeric coatings such as polyurethane or epoxy coatings, or ceramic coatings.

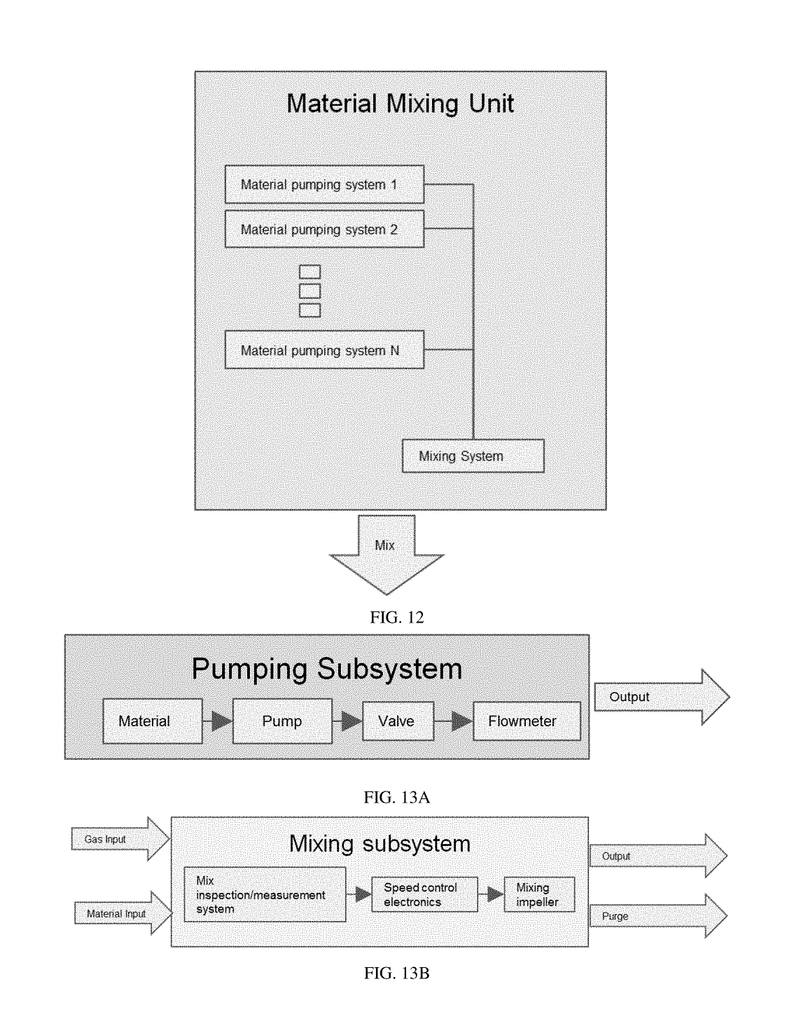

One non-limiting example of an architecture for a nozzle can be seen in FIG. 11. In this figure, a plurality of mixing units may be used to mix various fluids, and such mixtures, and/or a purge fluid, may be combined within a mixing chamber (e.g., within a nozzle), along with gas (for example, from a suitable source, such as a pressurized gas tank, controlled using a flow regulator, a valve, or another suitable system. The product, after mixing, may be controllably released through a valve to an outlet, and/or purged (for example, when different materials are mixed, as discussed herein). An example of a material mixing unit can be seen in FIG. 12. A plurality of different pumping systems may be used to combine two or more fluids together within a mixing unit.

Examples of architectures for various subsystems in certain embodiments of the invention can be seen in FIG. 13. In FIG. 13A, an example architecture for a pumping subsystem is shown. Material may be controlled by a pump and/or a valve, and optionally monitored by a flowmeter or other suitable sensor, e.g., as discussed herein. FIG. 13B illustrates the architecture for a mixing chamber. This may include, for example, one or more inputs (e.g., a gas input or a fluid input), various sensors to for example, inspect or measure mixing, a controller to control the impeller, e.g., the speed and/or positon, etc., which may lead to one or more outputs, e.g., a material output and a purge output.

It should be noted that these architectures are by way of example only, and in other embodiments, other architectures may be used, for example, for nozzles, mixing chambers, pumping subsystems, or the like.

In addition, in some embodiments, the composition or one or more of the fluids may be changed during the mixing process, e.g., to produce a change or a gradient in properties in the product. For example, the ratio of two reactants may be changed during mixing, or one reactant may be replaced with another reactant during mixing, etc. In some cases, a first fluid may be changed to a different fluid in a continuous manner, e.g., without interruption.

Non-limiting examples of properties that may change within a product include pore or cell size, density, stiffness, hardness, degree of cross-linking, chemical composition, or the like. The change may be a step change, or a more gradual change, e.g., producing a gradient in a property. For example, a foam or other product may exhibit a first portion having a first property (e.g., average pore size) and a second portion having a second property. Thus, for example, the product may have a first average pore size and a second portion that solidifies into a foam having a second average pore size, wherein the first average pore size is at least 10%, at least 20%, at least 30%, at least 40%, at least 50%, etc. greater than the second average pore size. There may be a gradual or abrupt change between the portions.

As used herein, a portion of an article may refer to any collection of points within the article (i.e., points that are within the portion of space bounded by the external surfaces of the article). Portions of the article are typically, but not always, volumes of space within the article (in some embodiments, a portion may be a surface within an article, a line within an article, or a point within an article). Portions of the article may be continuous (i.e., each point within the portion may be connected by a pathway that does not pass through any points external to the portion) or may be discontinuous (i.e., the portion may comprise at least one point that cannot be connected to at least one other point within the article by a pathway that does not pass through any points external to the portion). Portions of an article may be substantially homogeneous with respect to one or more properties (e.g., one or more properties of the portion may vary with a standard deviation of less than or equal to 1%, 2%, 5%, or 10% throughout the portion), and/or may be heterogeneous with respect to one or more properties (e.g., one or more properties of the portion may vary with a standard deviation of greater than or equal to 1%, 2%, 5%, or 10% throughout the portion).

In some embodiments, one or more properties of a mixture that is 3D-printed from a nozzle may change as a function of time and/or nozzle position with respect to the substrate. For instance, the composition of one or more components and/or the wt % of one or more components within the mixture may change as a function of time. In some embodiments, one or more physical parameters of the nozzle and/or the substrate may change as a function of time. As an example, the temperature of the nozzle and/or the substrate may change as a function of time. Without wishing to be bound by theory, the temperature of the nozzle and the temperature of the substrate may affect the types of reactions that occur between various components (e.g., cross-linking reactions, foaming reactions, reactions within the nozzle, reactions on the substrate) and/or the rates at which these reactions occur. This may in turn affect the chemical structure of the mixture (e.g., the composition of the mixture, the degree of cross-linking of the resultant foam) during and/or after printing, and/or affect one or more physical properties of the mixture (e.g., the viscosity of the mixture, the average pore size of the resultant foam, the density of the resultant foam, the stiffness of the resultant foam, the hardness of the resultant foam) during and/or after printing. In some embodiments, changes in substrate or nozzle temperature during printing may allow for different portions of the 3D-printed article (e.g., those printed at different times and/or in different positions on the substrate) to have different chemical or physical properties. In some embodiments, the portions with different chemical and/or physical properties may be printed in a single continuous process, and/or may together form a single integrated material.

In one set of embodiments, active mixing processes may be used to mix the fluids. For example, an impeller or other mixing apparatus may be used to mix fluids within the nozzle, e.g., in a mixing chamber within the nozzle. (However, it should be understood that an impeller is not necessarily required in all embodiments.) The impeller, if present, may have any shape or size able to cause the mixing of fluids. For instance, the impeller may include one or more vanes, blades, propellers, paddles, holes, and/or cavities, or the like, which may be used to cause movement (e.g., spinning) of fluids within the nozzle. In one embodiment, an impeller may include internal channels that allow a gas or fluid to enter through the impeller into the mixing chamber or nozzle. For instance, the nozzle may include a spindle having one or more openings that allow gas or other fluids to be released.

In addition, the impeller may be fabricated out of any suitable material, e.g., metal, ceramic, a polymer, or the like. In some cases, the impeller itself may be 3D-printed. The impeller may be controlled using any suitable technique, e.g., by mechanically, electrically, and/or magnetically rotating the impeller. In some cases, more than one impeller or other mixing apparatus may be used. Non-limiting examples of other mixing apparatuses and techniques include turbines or the application of ultrasound or additional fluids into the nozzle.

In addition, in some cases, no impeller or other mixing apparatus is used; for example, passive mixing techniques, such as controlling channel geometries or input flows, may also be used. For instance, ratios and/or compositions of incoming fluids may be controlled to control mixing, e.g., within a nozzle or mixing chamber. Combinations of mixing systems may also be used in certain embodiments, including combinations of active systems, or combinations of active and passive systems, for example, including any of the active or passive systems described herein.

In some cases, an impeller (or other mixing apparatus) may sweep through the nozzle or the mixing chamber such that the closest distance between the impeller as it travels and the wall of the nozzle or mixing chamber is less than 10 mm, less than 5 mm, less than 3 mm, less than 1 mm, less than 0.5 mm, less than 0.3 mm, less than 0.1 mm, less than 0.05 mm, less than 0.0.3 mm, less than 0.01 mm, less than 0.005 mm, etc. In some cases, the impeller may come into contact with the wall, although in other cases, the impeller may be at least 1 mm, at least 3 mm, at least 5 mm, or at least 10 mm away from the wall as it travels. In some cases, the impeller or other mixing apparatus may be one that substantially conforms to the shape of the nozzle or the mixing chamber in which the impeller or other mixing apparatus is located. For instance, the impeller may, upon rotation, sweep through a volume that is at least 50%, at least 60%, at least 70%, at least 80%, at least 90%, or at least 95% of the volume of the nozzle or the mixing chamber.

The impeller, if used, may be rotated at any suitable speed. For example, the impeller may be rotated at a speed of at least 5 rpm, at least 10 rpm, at least 20 rpm, at least 30 rpm, at least 40 rpm, at least 50 rpm, etc. In some cases, much higher rotation speeds may be used, e.g., at least 100 rpm, at least 200 rpm, at least 300 rpm, at least 500 rpm, at least 750 rpm, at least 1000 rpm, at least 2000 rpm, at least 3000 rpm, at least 5000 rpm, at least 7500 rpm, or at least 10,000 rpm. Higher rpm speeds may be useful in certain embodiments to create a froth or a foam. In some (but not all) embodiments, the impeller may be rotated at an rpm speed that is at least 16 times the residency time of the material in the mixing chamber or the impeller (for example, if the residency time is 10 seconds, then the rpm speed may be at least 160 rpm). In some cases, the impeller may be rotated at variable speeds. For instance, the impeller may be rotated at different speeds to control the formation or various properties of the foam or other product, and/or the impeller may be rotated to control the rate at which a material is deposited onto a substrate from the nozzle. In addition, in some cases, the impeller may be rotated at a speed that increases or decreases with respect to time. In some cases, changing the rotation speed of the impeller with respect to time may be used to alter a property of the foam or other product, e.g., from a first portion to a second portion. An example of a system that can be used to control the speed of the impeller can be seen in Int. Pat. Apl. Pub. No. WO 2016/164562, incorporated herein by reference.

In addition, in some embodiments, the impeller may be at least partially coated with a non-stick surface to prevent material build-up, as discussed herein.

In some cases, the impeller shape has a shape that allows it to fill the majority of the volume of the mixing chamber, such that the mixing volume is relatively small. When the mixing volume is relatively small, the material may have a relatively short residency time in the mixer, and the material properties or gradient structures can be varied quickly. In some cases, the free volume of the mixing chamber or nozzle (i.e., the volume therein not occupied by the impeller) may be less than 20 ml, less than 18 ml, less than 16 ml, less than 14 ml, less than 12 ml, less than 10 ml, less than 8 ml, less than 6 ml, less than 5 ml, less than 4 ml, less than 3 ml, less than 2 ml, less than 1 ml, less than 0.5 ml, less than 0.3 ml, less than 0.1 ml, etc. Thus, for example, in some embodiments, the impeller has a conical shape, e.g., if the mixing chamber or nozzle has a conical shape. In addition, in some cases, the impeller may be positioned such that the impeller as it travels has a distance from the wall of the nozzle or mixing chamber as discussed herein.

In one set of embodiments, the position of the impeller can be controlled or altered, for example, before or during mixing. The impeller may be actuatable with respect to the position of the mixing chamber, e.g., such that the mixing volume can be changed at any point to account for variable flowrate, thus keeping the residency time in the mixing chamber constant. For example, an actuator or servo may be able to move the impeller laterally within the mixing chamber, or towards an outlet, for example, during mixing or rotation of the impeller. In addition, in some cases, the impeller speed can be varied, such that the material experiences a fixed number of impeller rotations per residency time in the mix chamber.

In certain embodiments, the impeller can be used as a valve. For example, the end of the impeller may be directed into the outlet of the nozzle to block and close the nozzle, thereby preventing or controlling flow out of the chamber. For instance, the impeller may be directed forward (into the outlet) to prevent flow, and/or moved various distances relative to the outlet to allow different flows of fluid out of the nozzle.

In one set of embodiments, the nozzle and/or the mixing chamber may be heated or cooled. In some cases, the temperature of mixing may be controlled, for instance, to allow for uniform mixing, to facilitate reaction of fluids therein (e.g., to an optimum or desired temperature), to remove excess heat (e.g., contributed by a chemical reaction, the spinning of an impeller, etc.), or the like. Various methods can be used to add heat or remove heat from the nozzle or the mixing chamber. For example, a heat source may be positioned to deliver heat to the nozzle or mixing chamber, or to one or more fluids entering therein. Examples of heat sources include electrically resistive heaters, infrared light sources, or heating fluids (e.g., which can transmit heat using a heat exchanger or the like). In some cases, more than one heat source may be used. Similarly, a variety of cooling sources can be used in some embodiments to remove heat from the nozzle or mixing chamber. Non-limiting examples include Peltier coolers or cooling fluids (e.g., which can remove heat using a heat exchanger or the like). In some embodiments, some tubes and/or reservoirs that feed material to the pumps at the print head may be heated and/or cooled. This heating or cooling can be used to condition material inside of the tubes. Heating or cooling may prevent crystallization or phase separation of material in components of the system (e.g., tubes, mixing chamber). Heating or cooling may also enable processing of a wider range of materials that may be solid at room temperature.

Heating and/or cooling may, for example, be used to control mixing and/or reaction within the material, to keep the temperature at substantially the temperature of the surrounding environment (e.g., at room temperature), to prevent the surrounding environmental conditions and/or the heat generated by friction of the impeller and exotherm of the material curing from affecting the reaction or the printing parameters, or the like. In some cases, the temperature may be altered by at least 5° C., at least 10° C., at least 15° C., at least 20° C., at least 60° C., or by other ranges such as those discussed herein. In other embodiments, however, the temperature may be controlled or altered by no more than 20° C., no more than 15° C., no more than 10° C., no more than 5° C., etc. relative to the incoming fluids or the surrounding environmental conditions.

In addition, in some embodiments, one or more sensors may be present, e.g., within the nozzle or mixing chamber, within an outlet, within the substrate, or within sensing communication of the nozzle, mixing chamber, outlet, and/or substrate. Such sensors may be used to determine a property of the incoming fluids, the mixing process, and/or the exiting material (for example, the flowrate), e.g., qualitatively and/or quantitatively. In some cases, such information may be used to control the process, e.g., by controlling the flow of fluid into the nozzle or mixing chamber, the mixing speed (e.g., of an impeller), the flow exiting an outlet, the opening and closing of a valve at the outlet, or the like. Non-limiting examples include temperature sensors (e.g., thermocouples, infrared cameras, or the like), pressure transducers, photodiodes, colorimetric sensors, etc. In addition, more than one sensor can be used in some cases.

Fluid may be introduced into the nozzle or mixing chamber from one, two, three, or more inputs, in one set of embodiments. The inputs may independently have the same or different distances from the outlet of the nozzle or mixing chamber. As an example, two inputs may be near the top of a nozzle or mixing chamber, e.g., to allow two fluids to mix, and additional inputs may be lower, e.g., to introduce additional components (for instance, additives) as the fluids flow down the mixing chamber. As various non-limiting examples, this may be useful to allow reactions to occur in a certain order, to build viscosity first before starting to foam, to mix surfactants before adding filler, to mix ingredients prior to adding a catalyst, or the like.

In some embodiments, one or more of the inlets may be controlled using one or more valves or other apparatuses. In some cases, the valves may be controlled using a computer or other controller, e.g., as discussed herein. Thus, for example, valves may be used to control flow into (and/or out of) the nozzle. In some cases, valves may be used to control the flow of fluids through channel intersections, e.g., to keep fluids from reacting or curing too early (e.g., by creating a cured skin at the interface of an inactive channel). Examples of valves that can be used include, but are not limited to, needle valves, ball valves, gate valves, butterfly valves, and the like. The valves can independently be controlled, e.g., by electrical actuation, pneumatic actuation, or the like. In addition, in some cases, an impeller (if present) may be used as a needle valve, e.g., in conjunction with an outlet, as discussed herein.

The entering fluid may be gas, a liquid, a viscoelastic material, and/or any other flowable or deformable material. In addition, the entering fluid may include combinations of any of these in certain embodiments. In some cases, two or more fluids may be mixed prior to delivery, e.g., as discussed in detail herein. However, in some cases, two or more fluids may not be mixed prior to delivery. For instance, two or more inlets into the nozzle or mixing chamber may be used to introduce two or more separate fluids. These fluids can then be mixed in the nozzle or mixing chamber.

The fluids may be delivered using any suitable technique, and the same or different techniques may be used to deliver different fluids. For instance, fluids may be delivered passively (i.e., by gravitational flow), or actively (for example, by using pumps such as progressive cavity pumps, auger pumps, or the like). In some embodiments, the fluids may delivered using input channels that may have features to create turbulent flow and/or to cause passive mixing, e.g., as fluid flows through the channels. This may be useful, for example, in causing some mixing (for example, of a fluid with an additive) in order to occur prior to entry into a nozzle or mixing chamber such as described herein.

In some cases, active mixing may be used to control the delivery of different fluids. This may be useful, for example, for mixing fluids entering in at different flowrates (e.g., as in a 4:1 or 10:1 ratio), different viscosities, or the like. For example, in some cases, fluids that may be used include fluids that have relatively high viscosities, or viscoelastic solids that exhibit a yield stress, etc.

In some cases, a gas and a liquid may be mixed within the nozzle, e.g., as discussed above, to produce a froth. The gas may be added to the nozzle, and/or generated within the nozzle. The froth may comprise bubbles or pockets of gas dispersed within the fluid. The bubbles within the froth may be dispersed relatively uniformly or homogenously, or may have a relatively small average size. For example, the average bubble size within the froth may be less than 10 mm, less than 5 mm, less than 3 mm, less than 1 mm, less than 500 micrometers, less than 400 micrometers, less than 300 micrometers, less than 200 micrometers, less than 100 micrometers, less than 50 micrometers, less than 30 micrometers, less than 10 micrometers, less than 5 micrometers, etc. in average or characteristic diameter and/or the average bubble size may be at least 1 micrometer, at least 2 micrometers, at least 3 micrometers, at least 4 micrometers, at least 5 micrometers, at least 10 micrometers, at least 30 micrometers, at least 50 micrometers, at least 100 micrometers, at least 300 micrometers, at least 500 micrometers, at least 1 mm, at least 3 mm, at least 5 mm, etc. The bubbles may also exhibit a relatively uniform distribution of sizes, for example, such that at least 80%, at least 90%, or at least 95% of the bubbles within a sample of froth have an average diameter that is between 80% and 120%, or between 90% and 110% of the average bubble diameter. The gas may be introduced as one of the fluids entering the nozzle, and/or generated through chemical reaction of fluids within the nozzle. Non-limiting examples of gases that may be used include air, carbon dioxide, nitrogen, argon, or the like. In some cases, the froth may be deposited onto a substrate, e.g., as discussed herein. The froth may, in some embodiments, comprise at least 20%, at least 30%, at least 40%, or at least 50% by volume of gas.

In some cases, the nozzle may include more than one fluid that can be mixed with the gas. For example, in one embodiment, reactive fluids or fluids that contain surfactants that facilitate the introduction of the gas as bubbles in the fluids may be used. Examples of surfactants are discussed in more detail below. In some cases, mixing may occur relatively rapidly (for example, by spinning the mixing impeller at high velocity), and the froth would be in its near final form upon exiting the mixing nozzle. The froth may then be deposited or hardened to form a foam. The density of the froth (or the subsequent foam) can be varied by varying the ratio of the gas to the liquid. The mean bubble size in the froth (or the foam) can be varied, for example, by changing the impeller rotational velocity and/or the residence time in the nozzle or mixing chamber. The mechanical properties of the foam can also be changed, for example, by varying fluid compositions entering the nozzle during the formation process (for example, the ratio of isocyanate to polyol).

In some cases, producing froths or other materials containing gas within the nozzle, e.g., by mixing within the nozzle, may allow control over the froth or subsequent product that is formed. For instance, rheological properties may be controlled or altered by controlling mixing and/or the introduction of fluids within the nozzle. Froth development also may be at least somewhat independent of reaction rates, as it can be partially controlled by controlling external factors such as the mixing rate, e.g., at least in embodiments where no gas is produced by reaction (although in other embodiments, gases that contribute to the froth may desirably be produced by reaction).

In one set of embodiments, a material (for example, a froth), when deposited onto a substrate, may have a variety of rheological properties. For instance, the material may be substantially fluid and able to flow, e.g., to conform a mold or other substrate to which it is deposited. In some cases, the material may have a viscosity of less than less than 1,000 cP, less than 500 cP, less than 300 cP, less than 100 cP, less than 50 cP, less than 30 cP, or less than 10 cP. The material may also be Newtonian or non-Newtonian. In other embodiments, however, the material may exhibit some degree of solidity or elasticity, e.g., having a non-zero yield stress, and/or by exhibiting at least some resistance to a distorting influence or deforming force that is applied to the material. In some cases, the material may be sufficiently solid as to be able to define or hold a shape. For instance, the material may be sufficiently solid such that it deforms from its original shape by less than 10% (by volume) after deposition on a substrate, e.g., within 30 seconds after printing onto the substrate.

The substrate may be any suitable target for a material exiting a nozzle. In some cases, the substrate is planar, although in other cases, the substrate is non-planar. For instance, the substrate may be a mold (e.g., the mold of a shoe), to which a material may be introduced. In some cases, the material may be relatively fluid and able to conform to contours within the substrate (e.g., if the substrate is a mold). However, in other cases, the material may be relatively solid, e.g., having a defined shape, upon deposition onto the substrate, such as is discussed herein.

In some cases, the substrate may also be heated or cooled, e.g., to promote or inhibit a reaction, to cause solidification to occur, or the like. In some cases, the temperature may be altered by at least 5° C., at least 10° C., or by other ranges such as those discussed herein. Any method may be used to heat or cool the substrate. For example, heat or cooling sources may be used to apply heat or cooling to the substrate, the substrate may be contained within a heated or cooled environment, or a source of a heated or cooled fluid may be used to heat or cool the substrate, e.g., via a heat exchanger). In one embodiment, radiant light or infrared radiation may be applied to the substrate for heating.

As a non-limiting example, in one embodiment, a two-stage foaming system that implements two foaming types may be used. For example, using mechanical frothing in the nozzle may be used to mix a Newtonian liquid with a blowing agent into a printable viscoelastic foam formulation. After deposition, the polymer in the foam may be completely or partly cured. The temperature of the polymer can be raised to drive the decomposition of the blowing agent, and the subsequent expansion of the foam.

As another non-limiting example, a nozzle involving mechanical frothing may be used to create a foam having a yield stress that behaves viscoelastically. After deposition, the foam may be heated to achieve further expansion of the foam. This secondary expansion can be carried out, for example, using an agent, such as azodicarbonamide. For example, one or more inputs can be used to deliver a polyol loaded with surfactant and a blowing agent into a nozzle, which are then mixed together, e.g., such that a froth is formed.

In some aspects, two or more fluids may be mixed prior to introduction into a nozzle. In some cases, the fluids may be mixed in a second nozzle or mixing chamber (e.g., separate from the first nozzle), and in some cases, a series of mixing chambers may be used, in any arrangement, e.g., in series and/or parallel. Thus, in some embodiments, more than one stage of mixing or combining fluids may be used. As non-limiting example, FIG. 2 shows a mixing chamber that outputs into an input of a printing nozzle, while FIG. 3 shows two mixing chambers in series with a printing nozzle. In one set of embodiments, the mixing chambers may be in nozzles similar to the printing nozzles described herein, e.g., having any of the dimensions described herein with respect to printing nozzles, and optionally with an impeller, e.g., as described herein with respect to printing nozzles. However, in other embodiments, the mixing chambers may have substantially different shapes and/or sizes. If two, three, or more impellers are present, the impellers may be independently controlled in some instances.

Mixing within a mixing chamber may be relatively complete, or may be partial in some cases. In addition, in some cases, no mixing may occur in a mixing chamber, other than incidental mixing or diffusion (for example, as two fluids come into contact with each other). As noted above, more vigorous mixing can occur within the printing nozzle, which may lessen the need for complete mixing to occur upstream. However, in other embodiments, more complete mixing may occur within one or more mixing chambers upstream of the printing nozzle.

In some aspects, one or more purge fluids may be used to purge one or more of the inlets, outlets, nozzles, and/or mixing chambers, etc. For example, a purge fluid may be passed through one or more of these when they are not actively being used to mix or print, and/or to clear fluids so that different fluids can be used. For instance, a purge fluid may flow through an inlet when switching the inlet from a first fluid source to a second fluid source, e.g., to purge residual fluid from the first fluid source that may be present. The purge fluid may flow through the nozzle in some cases, and/or be removed prior to the nozzle. Non-limiting examples of purge fluids include gases such as air, carbon dioxide, nitrogen, argon, or the like, and/or liquids such as water (which may be pure, contain one or more additives such as surfactants in some cases, etc.). Purge fluids could also be a non-reactive paste such as petrolium jelly or a viscous silicone oil or paraffin wax, or an aqueous or alcohol based gel such as pluronic or carbopol. Combinations of purge fluids may also be used in some embodiments.

As a non-limiting example of use of a purge fluid, a nozzle may have a first inlet and a second inlet, in which two fluids (A and B) are reacted together to produce a first product. The nozzle may also be used to produce a second product also formed from two fluids (A′ and B′), where one or both of A′ and B′ are different than A and B. Both A and A′ may be introduced using the first inlet, while B and B′ may be introduced using the second inlet. To avoid contamination of A with A′ and/or B with B′, one or more purge fluids may be introduced between introducing A and A′ to the nozzle and/or B and B′ to the nozzle. In some cases, sufficient purge fluid may be introduced to clear the entire nozzle or mixing chamber between different fluids, although in other cases, some degree of contamination may be deemed to be acceptable, e.g., the purge fluid may be used to reduce but not completely eliminate contamination. The introduction of more than one fluid into an inlet may be controlled using any suitable technique; e.g., one or more fluid sources may be able to be placed in fluid communication with an inlet, where control of such fluid communication may be controlled using one or more valves (e.g., needle valves or other valves such as those discussed herein), which in some cases may be controlled using a computer or other controller.

As a non-limiting example, FIG. 5 illustrates the use of a nozzle or mixing chamber with only one input. In this figure, nozzle 15 includes an outlet 18 and a single input 39. However, in fluidic communication with input 39 are a plurality of different sources of fluid 51, 52, 53, 54, and 55. (Five sources are provided here by way of example only, but more or fewer sources may be used in other embodiments.) In this figure, source 51 may be, for example, a purge fluid, while sources 52, 53, 54, and 55 may be sources of various fluids or reactants to be introduced into nozzle 15. As a non-limiting example, different combinations of reactants may be introduced into the nozzle from the different sources of fluid, while purge fluid from source 51 may be used to purge inlet 39 between different fluids, e.g., to reduce contamination.

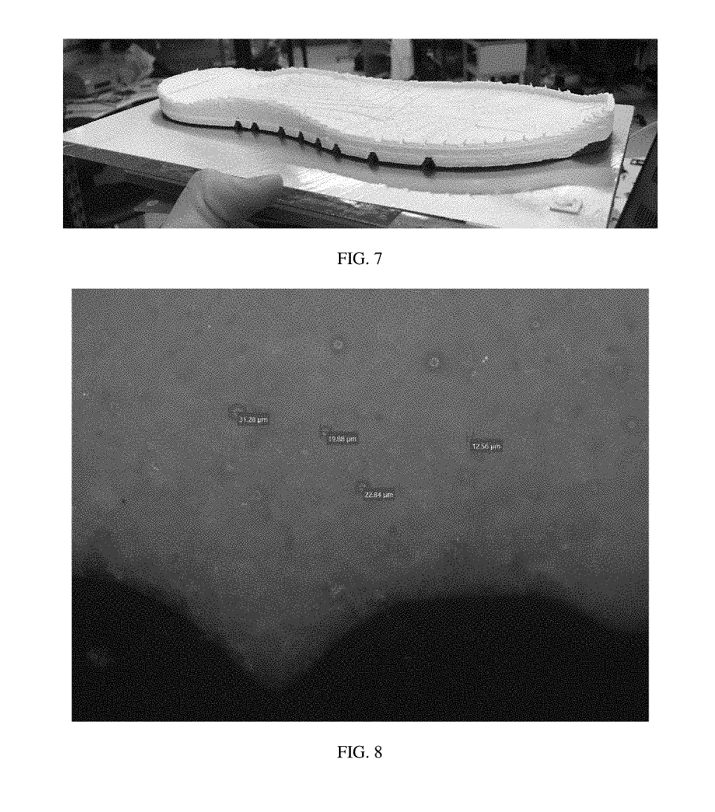

FIG. 6 illustrates a system in which a purge fluid may be withdrawn at various locations. In this figure, nozzle 15 includes an inlet 31 in fluid communication with a source of purge fluid 51 and a sources of other fluids 52 and 53. (Two are shown here for explanatory purposes, but more or fewer sources may be used in other embodiments.) Also shown in this figure are outlets 63 and 65, in addition to outlet 18 of the nozzle. The flow of fluid may be controlled by one or more valves or other apparatuses, e.g., controlled by a computer or other controller. Thus, in this example, a purge fluid may be introduced from fluid source 51 and controllably withdrawn using outlet 63 (i.e., without entering nozzle 15), outlet 65 (i.e., passing through nozzle 15 but not outlet 18), or outlet 18. Other purge configurations are also possible in other embodiments.

In various aspects, a variety of foams or other products may be produced. For example, in some embodiments, a foam may be created from a foam precursor comprising a polymer and a cross-linking agent. The polymer can comprise polyol such as a low number average molecular weight diol, high number-average molecular weight diol, a low number-average molecular weight triol, a high number-average molecular weight triol, or a high number-average molecular weight monol. For instance, a high molecular weight monol, diol, or triol may have a number-average molecular weight of greater than 300, 400, or 500, while a low molecular weight monol, diol, or triol may have a number-average molecular weight less than 300, 400, or 500. Other examples of polymers include, but are not limited to, epoxies, acrylates, cyanate esters, silicones, polyesters, phenolics, hydrogels, or the like.

In one set of embodiments, the polymer includes a polyurethane, e.g., formed by reacting the polyol with an isocyanate. The polyol may be any suitable polyhydroxy compound. For example, the polyol may be a hydroxy-terminated ester, ether or carbonate diol, or a hydroxyl-terminated polybutadiene polymer. Non-limiting examples of polyalkylene ether glycols include polyethylene ether glycols, poly-1,2-propylene ether glycols, polytetramethylene ether glycols, poly-1,2-dimethylethylene ether glycols, poly-1,2-butylene ether glycol, and polydecamethylene ether glycols. Examples of polyester polyols include polybutylene adipate and polyethylene terephthalate. Examples of polycarbonate diols include polytetramethylene carbonate diol, polypentamethylene carbonate diol, polyhexamethylene carbonate diol, polyhexane-1,6-carbonate diol and poly(1,6-hexyl-1,2-ethyl carbonate)diol. However, many other suitable polyhydroxy compounds can also be used depending upon the desired application. Any suitable polyol, polythiol or polyamine or mixture thereof that is suitable for this purpose may be used, such as, for example, mixed diols comprising a 2,4-dialkyl-1,5-pentanediol and a 2,2-dialkyl-1,3-propanediol. Specific examples of 2,4-dialkyl-1,5-pentanediols include 2,4-dimethyl-1,5-pentanediol, 2-ethyl-4-methyl-1,5-pentanediol, 2-methyl-4-propyl-1,5-pentanediol, 2,4-diethyl-1,5-pentanediol, 2-ethyl-4-propyl-1,5-pentanediol, 2,4-dipropyl-1,5-pentanediol, 2-isoptopyl-4-methyl-1,5-pentanediol, 2-ethyl-4-isoptopyl-1,5-pentanediol, 2,4-diisopropyl-1,5-pentanediol, 2-isopropyl-4-propyl-1,5-pentanediol, 2,4-dibutyl-1,5-pentanediol, 2,4-dipentyl-1,5-pentanediol, 2,4-dihexyl-1,5-pentanediol, and the like. Specific examples of 2,2-dialkyl-1,3-propanediols include 2,2-dipentyl-1,3-propanediol, 2,2-dihexyl-1,3-propanediol and the like.

In some cases, longer-chain or higher molecular weight polyols may be used to produce relatively softer materials because they have more polyol relative to isocyanate. In some cases, the isocyanate can also be underindexed compared to the number of reactive sites on the polyol to make a softer foam that behaves less elastically.

The cross-linking agent, if present, can comprise an isocyanate in some cases, and/or an isocyanate prepolymer. An isocyanate may have more than one functional isocyanate group per molecule and may be any suitable aromatic, aliphatic or cycloaliphatic polyisocyanate. In some cases, the isocyanate is a diisocyanate. One non-limiting example is an organic diisocyanate, such as methylene diphenyl diisocyanate. Additional examples of organic diisocyanates include 4,4′-diisocyanatodiphenylmethane, 2,4′-diisocyanatodiphenylmethane, isophorone diisocyanate, p-phenylene diisocyanate, 2,6-toluene diisocyanate, polyphenyl polymethylene polyisocyanate, 1,3-bis(isocyanatomethyl)cyclohexane, 1,4-diisocyanatocyclohexane, 1,6-hexamethylene diisocyanate, 1,5-naphthalene diisocyanate, 3,3′-dimethyl-4,4′-biphenyl diisocyanate, 4,4′-diisocyanatodicyclohexylmethane, 2,4′-diisocyanatodicyclohexylmethane, and 2,4-toluene diisocyanate, or combinations thereof. In some cases, an isocyanate prepolymer may be used, e.g., in addition to and/or instead of an isocyanate. For instance, where two isocyanates are added to the ends of a polyol, so it still has functionality of two, but with a higher molecular weight.

In addition, it should be understood that a cross-linking agent is not required. For example, in some embodiments a polymer (such as a thermoplastic polyurethane) can be mixed with fillers and frothed in a nozzle or a mixing chamber, then cooled upon exiting to form a foam.

In some embodiments, no foam is produced and a crosslinked product results. As a non-limiting example, a high number-average molecular weight diol may be mixed with an isocyanate (e.g., a diisocyanate, or other isocyanates described herein) and deposited onto a substrate, e.g., to produce a thermoplastic elastomer. In another embodiment, a low number-average molecular weight diol can be mixed with an isocyanate and deposited onto a substrate, e.g., to produce a rigid thermoplastic. In yet another embodiment, a high number-average molecular weight diol and a high number-average molecular weight triol can be mixed, and then the polyol mixture mixed with an isocyanate and deposited onto a substrate, e.g., to produce a flexible thermosetting elastomer with high resiliency.

In some embodiments, the foam precursor comprises a polyurethane, an epoxy, a silicone, a cyanoacrylate, an adhesive, a cyanate ester, a polyester, a polyimide, a phenolic, or another suitable material. In another embodiment, the foam precursor could comprise a decomposeable binder and particles which stabilize the bubble interface. In some cases, the particles may be sintered at the bubble interface to form a non-polymeric foam, e.g., a metal foam or a ceramic foam.

As a non-limiting example of a foam, in one embodiment, a high number-average molecular weight diol and a high number-average molecular weight triol are mixed with a surfactant, and then the polyol-surfactant mixture is mixed with an isocyanate. The foam precursor that results may be mixed with nitrogen, or another gas, and deposited onto a substrate. Mixing techniques such as those discussed herein, e.g., involving more than one stage of mixing or combining fluids, may be used.

As yet another non-limiting example, a high number-average molecular weight diol and a high number-average molecular weight monol are mixed with a surfactant, and then the polyol-surfactant mixture is mixed with an isocyanate. Mixing techniques such as those discussed herein, e.g., involving more than one stage of mixing or combining fluids, may be used. The foam precursor that results is then mixed with nitrogen, or another gas, and deposited onto a substrate. This may be used to produce memory foam, or other types of foam.

As mentioned, in some embodiments, a surfactant may be used to produce a foam or other product as discussed herein. For example, a surfactant may be used to facilitate the introduction of gas into a fluid, the subsequent stability of the bubbles that are formed, and/or the rheology of the foam can be altered or tuned using various surfactants, or altering their concentration, etc. For instance, in one embodiment, a surfactant may be used that comprises a first moiety with affinity for an air-liquid interface, e.g., to facilitate the introduction of gas into a fluid. Non-limiting examples of such surfactants include sodium stearate, sodium dodecyl sulfate, or silicone-based surfactants such as silicone polyethers. Many such surfactants are widely available commercially.

In some cases, a surfactant molecule may be used that allows production of a high yield stress foam, e.g., a foam able to maintain its shape after deposition on a substrate. For example, in some embodiments, a high-yield stress inducing surfactant is one where the end of the surfactant is more soluble in the continuous phase of the foam precursor. The surfactant may have a relatively high molecular weight, and may be non-ionic. Non-limiting examples of such surfactants include surfactants with a molecular weight of greater than or equal to 1500 g/mol. In addition, in some cases, a surfactant molecule may be used that allows production of a low yield stress foam, e.g., a foam unable to maintain its shape after deposition on a substrate, and the foam may conform to the material around it after deposition. In some embodiments, a low-yield stress inducing surfactant is one where the soluble end may be either charged or have a relatively low molecular weight, e.g., such that no entanglement between the surfactants is able to occur. Non-limiting examples of such surfactants include surfactants with a low molecular weight (e.g., silicone surfactants with a low molecular weight). In addition, in some embodiments, different types of surfactants may be used, e.g., a high yield and a low yield surfactant. By varying the relative concentration of the first surfactant and the second surfactant in the mixture, the resultant foam may vary from high yield stress to low or no yield stress, depending upon the application.

In certain embodiments, the first surfactant molecule may comprise a first moiety having an affinity for an air-liquid interface, and a second moiety that comprises a long chain that is soluble in the foam precursor and prone to entanglement. The second surfactant molecule may, in some instances, comprise the same first moiety with affinity for the air-liquid interface, and a second moiety that comprises a short chain with an electrostatic charge. The electrostatic charge may in some cases be such that the cells of the closed-cell foam repel one another and can move freely past one another.

The cell-forming agent, in some embodiments, forms cells within a material such as a foam or froth, as discussed herein. For instance, the cell-forming agent may comprise water, and/or a gaseous material such as air, carbon dioxide, nitrogen, butane, or the like. In some embodiments, the cell-forming agent comprises a blowing agent that is added that can generate a gas, e.g., chemically. The microfluidic printing nozzle may disperse the blowing agent in a material, for example a polymer, to form a two-phase mixture of blowing agent cells within the polymer. Thus, the blowing agent can comprise a material that decomposes into a gas, e.g., at an elevated temperature. In some cases, the blowing agent can comprise a gaseous material that maintains its liquid state by cooling or pressurization, and reverts to its native gas state when the pressure is released or the blowing agent is heated, which may cause the blowing agent to form a gas, e.g., to cause cells in the polymer to grow. The resultant gas may become trapped in cells within the material, e.g., forming a foam.

As an example of use of a blowing agent, the microfluidic printing nozzle may mix a blowing agent with a material, for example a polymer, which may undergo a chemical reaction to cause the formation of a gas. Chemical blowing agents may include generally low molecular weight organic compounds that decompose to release a gas such as nitrogen, carbon dioxide, or carbon monoxide. Non-limiting examples of chemical blowing agents include azo compounds such as azodicarbonamide. In some cases, the blowing agent may be activated on the surface of a printed article to produce a rough surface finish, e.g., to impart a matte finish or a soft feel to the exterior of a printed article.

Thus, in some cases, the blowing agent can be used to create foams that form cells by induction by heat, removal of pressure, or the like. For instance, a foam precursor can be mixed with the blowing agent and deposited onto a substrate or part without forming cells until after deposition, or with only partially formed cells. Thus, in some cases, material may be deposited onto a substrate, then induced to form cells by heating the material. After deposition, cells may form within the product, e.g., by induction by heat, removal of pressure, or the like.

As a non-limiting example, a foam may comprise an ethylene-vinyl acetate foam, which may be utilized in footwear or other applications. A blowing agent may be selected such that the agent phase-transitions into a gas at a temperature at which the polymer containing it is soft and malleable. In some cases, the polymer can expand (e.g., expand up to 200%) as the cells form without rupturing, and the resultant material can be cooled to form a solid foam.

As another example, water may be used in another embodiment as a cell-forming agent. For example, a water-blown foam may be produced where water and a surfactant are mixed into a polymer component, which is then mixed with isocyanate or another substance able to react with water, e.g., to produce a gas. For instance, as a non-limiting example, isocyanate chemically reacts with both water and polyol; the reaction of polyols with isocyanate may be used to increase the molecular weight of the polymer, e.g., to form a polyurethane, while the reaction of water with the isocyanate forms carbon dioxide gas. The carbon dioxide gas becomes trapped in the polymer as it solidifies, and a foam is thus created. In some cases, the amount of water may be controlled to control the properties of the resulting foam, such as density or cell size, e.g., during the reaction process.

In addition, in some embodiments, a material may be deposited onto a substrate, e.g., to fill a mold, then the mold may be sealed and the blowing agent induced to form a foam, which may then start to fill in the mold as the foam expands.

In some embodiments, additives are introduced into the mixture. They may be introduced at any suitable point, for example, directly into a nozzle or mixing chamber (e.g., through one or more separate inlets), or upstream of the nozzle or mixing chamber (e.g., using a series of mixing chambers, as described herein). In some embodiments, an additive may be added directly to another fluid (e.g., without necessarily requiring a mixing chamber). These additives can comprise particles, hollow glass spheres, a pigment, a metal, a filler such as a thermally conductive filler, a filler having a relative dielectric constant of at least 5, an ultraviolet stabilizer, a filler concentrate, or another suitable additive. Additional examples of additives include surfactants (e.g., silicone surfactants), catalysts, nucleation promotors, fillers for better abrasion resistance, chemical foaming agents, etc. Combinations of these and/or other additives are also possible. As a non-limiting example, a 3D printed closed-cell foam may be produced that incorporates particulate additives comprising a cellular network of cell walls separating empty cells, where the cell walls comprise a polymer composite including filler particles dispersed in a polymer matrix.

As a non-limiting example, hollow glass spheres may be incorporated into polyurethanes or other polymers as discussed herein to reduce density, increase stiffness, reduce dielectric constant, provide more nucleation sites for bubble formation, or the like. For instance, hollow spheres may be used to decrease weight. Hollow glass spheres can be varied, e.g., spatially, in order to change the properties of the product. In some embodiments, hollow polymer spheres may be used instead of or in addition to hollow glass spheres.

In one aspect, a foam may be printed (e.g., via 3D-printing) into a structure defining a plurality of cells, i.e., into a foam-like structure. Thus, a foam may be printed as part of a larger foam-like structure, e.g., where the walls of the foam-like structure (e.g., defining cells of the foam-like structure themselves) are foams having cells. The foam-like structure may have open cells, closed cells, or any combination of open and closed cells, independently of the structure of the foam itself forming the foam-like structure.

The Inventors recognized the problem that some particles (e.g., fumed silica), which can be used to change the rheology and/or mechanical properties of a material (e.g., a polymeric material), are difficult to use in spraying methods for deposition of material. The degree of particle incorporation may be useful, for example, in controlling whether a material deposited onto a fabric sits on top of the fabric (e.g., material with a sufficient volume percent of the particles) or seeps into the fabric. As an alternative to incorporating particles into a material, the Inventors have determined that exposing a light-curable material to light (e.g., UV light) of an appropriate curing wavelength upon the material exiting a printing nozzle, or after a predetermined delay between exiting the printing nozzle and light exposure, results in a similar rigidifying effect on the material to that resulting from particle incorporation. The Inventors have further determined that light curing can be used to control the mechanical properties of materials that can be deposited by spraying (e.g., using compressed gas to aerosolize the material), which may result in both better mechanical properties control and higher throughput relative to other printing methods. In addition, the Inventors have determined that combining a printing nozzle (e.g., having a mixing chamber and an impeller disposed in the mixing chamber) configured to actively mix small volumes of material with a compressed gas source, an outlet of which printing nozzle intersects with an outlet in fluid communication with the compressed gas source, a print head with spraying capabilities results in which input ratios (e.g., volume ratios) into the printing nozzle, and therefore material composition of the sprayed material, can be changed on the fly.

In some embodiments, it can be useful deposit material onto surfaces by spraying rather than by extrusion alone through a nozzle. Advantages of spraying relative to extrusion alone may include but are not limited to deposition of thinner films with no extrusion lines; reduced sensitivity to nozzle standoff distance from the substrate; and/or a capacity to create wider strips of material in one pass to reduce cycle time. Other advantages of spraying relative to extrusion alone may include limited accumulation or no accumulation of cured material on the nozzle, which may be because spraying may not require the spray nozzle to come into direct fluid communication with material that has already been deposited. In addition, coatings made by spraying can be applied conformally to three-dimensional (3D) surfaces without precise alignment or 3D tool-pathing.

In some embodiments, it is possible to make slight modifications to a mixing nozzle (e.g., a 4-input dynamic mixing nozzle) to convert it into a spray nozzle. In order to do this, a compressed gas guiding sheath fluidly connected with a compressed gas source may be attached around the outside of the nozzle. In some embodiments, a configuration of an impeller disposed in the mixing chamber of the mixing nozzle ensures that a small mixing volume is retained such that rapid changes in the sprayed material composition can be executed. In some embodiments, the compressed gas guiding sheath (e.g., air guiding sheath) is configured to guide the flow of compressed gas from a compressed gas source to atomize the output of the nozzle into small droplets immediately upon exiting the nozzle. In some embodiments, the small droplets are then propelled through the air to land on a target substrate. In some embodiments, ratio(s) (e.g., volume ratios) of the inputs (e.g., 4 inputs) into the mixing chamber can be changed in space and time to vary the composition of the material that is sprayed. In some embodiments, the geometry of the compressed gas guiding sheath and/or the applied pressure from the compressed gas can be used to change the shape and velocity of the cone of atomized material that is deposited. In some embodiments, the standoff distance from the substrate can be used to control the width of the sprayed strips.

A potential limitation of spraying (e.g., spraying a mixture of chemically reactive materials) may be that depending on the applied pressure from the compressed gas through the compressed gas guiding sheath, the sprayed films that are deposited onto the substrate can be deformed after deposition by the force of the compressed gas blowing against them. In embodiments where spraying a mixture of chemically reactive materials occurs, one solution to this problem may be to induce the mixture of materials to react more quickly and become solid very quickly so that the mixture can withstand the forces of the compressed gas without permanent deformation. However, this solution may create risks of accumulating cured material inside of a mixing nozzle (e.g., inside of a mixing chamber) during deposition. Another solution may be to add a UV-curable component to one or more inputs that are mixed together in the mixing chamber. As a non-limiting example, free radical polymerization between materials with alkene functional groups (e.g., acrylates, methacrylates, vinyls) may proceed very rapidly (e.g., in fractions of a second) when exposed to high power UV irradiation, but may also remain stable for months when not exposed to UV irradiation. After adding a UV-curable component to the mixture, the mixture can be exposed to UV irradiation directly as it exits the mixing chamber. The exposure to UV irradiation may increase the viscosity of the resulting material very rapidly to the consistency of a non-flowing paste or gel that can withstand forces from the compressed gas without deformation. This rapid increase in viscosity may also prevent the deposited material from soaking into porous fabrics, and may enable structures of substantial thickness to be built up. Since the UV-curable components of the system may represent only a fraction of the total functional groups that have the capability of reacting to form a solid polymer, the deposited material may continue to increase in viscosity, and also may form chemical bonds with previously deposited material as functional groups in the mixed material (e.g., isocyanates and one or more of alcohol groups or amine groups) curable by means other than UV exposure continue to react with one another after the UV irradiation (e.g., high power UV irradiation) is removed. In some cases, a UV-curable component of the mixture may be a urethane acrylate that does not have any alcohol or isocyanate groups present on it. In some cases, UV-curable component(s) of the mixture may be present within the same molecule that also has one or more functional groups curable by means other than UV exposure (e.g., alcohol, amine, or isocyanate groups). The mass percentage of molecules that contain UV-curable functionality may be as high as 100% for any individual input. The mass percentage of molecules that contain UV-curable functionality may be as high as 60% for the final mixture in the case that molecules containing UV-curable functional groups are present on different molecules from the molecules containing one or more functional groups curable by means other than UV exposure (e.g., isocyanates, alcohols, or amines). In the case where UV-curable functional groups are present on the same molecules that also contain one or more functional groups curable by means other than UV exposure (e.g., isocyanates, alcohols, or amines), as much as 100% of the molecules may contain at least one UV-curable functional group. In the case that a hybrid UV-curable mixture is used, wherein UV-curable functional groups are present as well as one or more functional groups curable by means other than UV exposure, an irradiation source (e.g., a UV irradiation source, a light source, a UV light source) may be integrated into (or adjacent to) the print head, such that the hybrid UV-curable mixture may be UV cured immediately upon exiting the nozzle. The irradiation source (e.g., UV irradiation source) may comprise one or more UV LEDs, each with a peak wavelength between or equal to 200 nm and 405 nm. The irradiation source (e.g., UV irradiation source) may also comprise mercury lamps or bulbs. The irradiation source may also comprise a light source with a peak wavelength outside of the UV spectrum, provided that the intensity of irradiation in the UV spectrum is sufficiently high to activate a photoinitiator in the system. Additionally, the irradiation source may be one or more DLP (Digital Light Projection) projectors. The projectors may have lenses that direct the light (e.g., focus the light) onto a small region, but enable the light in that region to be patterned. The projectors can be used to change the shape of an image that is projected so that the light is directed only onto regions that require exposure.

In some cases, it may be advantageous for the hybrid UV-curable mixture to experience a delay between exiting the nozzle and initial exposure to the irradiation source (e.g., UV irradiation source). This delay may allow the deposited material to level and spread, and/or to soak into the surface of the substrate (e.g., the fabric surface) to some degree before the viscosity of the extruded material increases substantially. This leveling, spreading, and/or soaking in can produce more uniform and flat films deposited with this method, relative to immediate exposure of the mixture to the irradiation source as it leaves the nozzle. In other cases, it may be advantageous to have no delay in exposure of the mixture to the irradiation source as it leaves the nozzle, such that the material that is deposited holds its shape without spreading or leveling. In some cases, a region surrounding the nozzle tip may be exposed to irradiation (e.g., UV irradiation) continuously, and the rate of increase of viscosity of the mixture may be controlled by the mass fraction or volume fraction of UV-curable material present in the mixture, which can be controlled zonally by varying the ratios of two or more inputs into the mixing chamber.

It should also be understood that while the scope of this disclosure has focused on examples of functional groups curable by means other than UV exposure directed to polyurethane formulations, for spraying and/or extrusion of a hybrid UV-curable mixture, other material chemistries may be used to replace the polyurethane formulations. For example, a mixture for spraying and/or extrusion may be made with epoxies where one component contains epoxide functional groups, and another component contains amine functional groups. In another example of a mixture, one component may include siloxane functional silicone resins and a platinum catalyst, and another component may include vinyl functional silicone resins, which would react after mixing to form polydimethylsiloxane (PDMS) elastomers. Polydimethylsiloxane resins that cross-link through multiple chemistries may also be used (e.g., tin-cured, or acetoxy-based systems). Polydimethylsiloxane resins may also be partially or fully UV-curable, e.g., by adding acrylate functional groups to the silicone resins, or by employing a catalyst that is de-blocked by exposure to UV light.

Other variations of a nozzle include but are not limited to: a spray nozzle with a compressed gas source and/or a compressed gas guiding sheath without an irradiation source (e.g., without a UV light source) with at least two inlets to the nozzle, for depositing a reactive system having two or more parts without any UV-curable components; or a nozzle with two inlets and (in some cases without a compressed gas source or guiding sheath but) including an irradiation source (e.g., a UV irradiation source), for depositing by extrusion (in some cases without spray functionality) a reactive system having two or more parts with some irradiation-curable (e.g., UV-curable) components.

In any variation of the nozzle (e.g., mixing nozzle), the nozzle may have one input or two inputs or more than two inputs (e.g., 3, 4, 5, 6, 7, 8, 9, 10, or more inputs).

In some embodiments, a print head is provided.

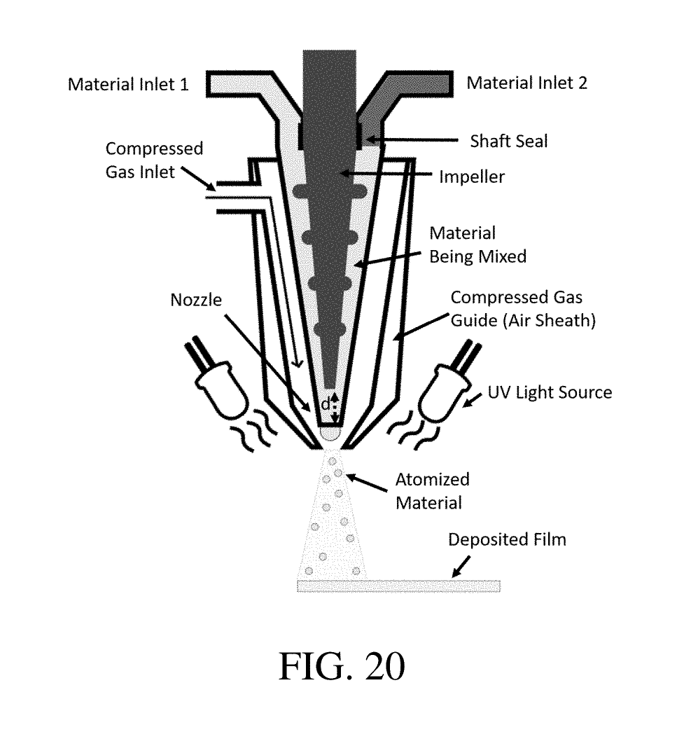

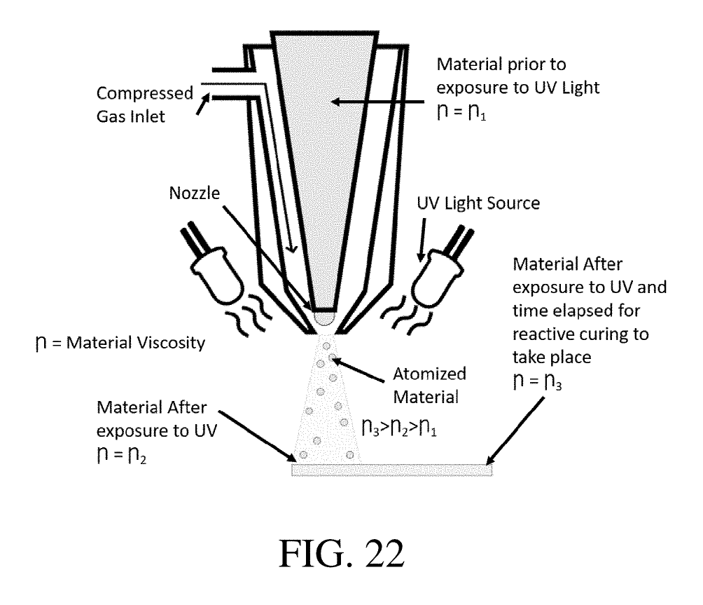

The print head can have a printing nozzle, which can have a mixing chamber, an impeller disposed in the mixing chamber, and two or more material inlets in fluid communication with the mixing chamber (see, e.g., FIG. 20). In some embodiments, a tip of the impeller is less than 5 mm from an outlet of the printing nozzle. In some embodiments, an outlet of the printing nozzle (e.g., of the mixing chamber) is configured to intersect with an outlet fluidly connected to the compressed gas source (see, e.g., FIG. 20, FIG. 22). In some embodiments, a volume of the mixing chamber is less than 1 mL. In some embodiments, the volume of the mixing chamber is less than 250 microliters. In some embodiments, the mixing chamber is in fluid communication with three or more material inlets. In some embodiments, the mixing chamber is in fluid communication with four or more material inlets. In some embodiments, one or more of the material inlets is in fluid communication with a respective in-line rotary pump.

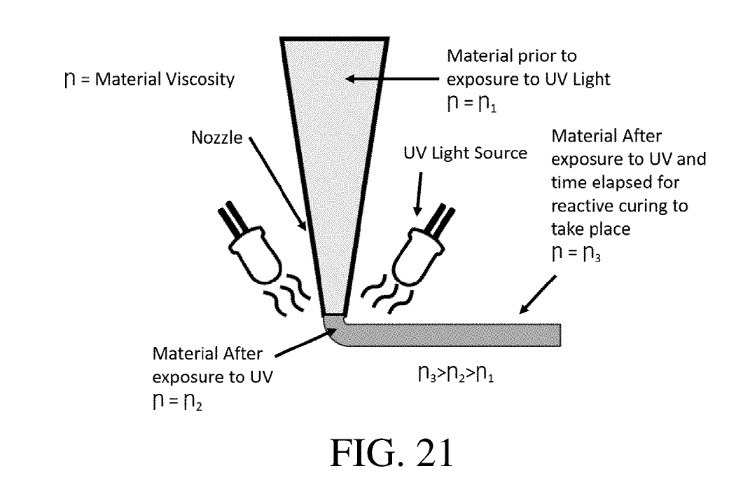

The print head can have a light source (e.g., an ultraviolet (UV) light source) adjacent to the printing nozzle (see, e.g., FIG. 20, FIG. 21, FIG. 22). In some embodiments, the light source (e.g., UV light source) comprises an emission wavelength between or equal to 200 nm and 405 nm. In some embodiments, the light source (e.g., UV light source) is configured to irradiate a material directly as the material exits the printing nozzle (e.g., exits the mixing chamber). In some embodiments, the light source (e.g., UV light source) is configured to irradiate a material after the material exits the mixing chamber with a predetermined delay. In some embodiments, the light source (e.g., UV light source) comprises an emission wavelength between or equal to 200 nm and 405 nm. In some embodiments, the light source (e.g., UV light source) comprises one or more light emitting diodes (LEDs) (e.g., UV LEDs). In some embodiments, the light source (e.g., UV light source) is one or more Digital Light Projectors (DLP).

The print head can have a compressed gas source (see, e.g., FIG. 20, FIG. 22). In some embodiments, the compressed gas source is configured to atomize a material extruded from the printing nozzle (e.g., from the mixing chamber). In some embodiments, the compressed gas source is in fluid communication with an electropneumatic regulator.

In some embodiments, the print head has a compressed gas guiding sheath fluidly connected to the compressed gas source (see, e.g., FIG. 20, FIG. 22). In some embodiments, an outlet of the mixing chamber is configured to intersect with an outlet of the compressed gas guiding sheath. In some embodiments, the compressed gas guiding sheath is a microfluidic gas guiding sheath. In some embodiments, the compressed gas guiding sheath (e.g., microfluidic gas guiding sheath) is actuatable such the sheath can be moved with respect to an outlet of the printing nozzle or vice versa. In some embodiments, the compressed gas guiding sheath (e.g., microfluidic gas guiding sheath) is coupled to the print head through magnetic attachment such that it can be easily removed. In some embodiments, the compressed gas guiding sheath (e.g., microfluidic gas guiding sheath) has multiple gas channels coupled to valves that can be addressed individually. In some embodiments, moving the sheath with respect to the outlet of the printing nozzle changes channels through which compressed gas is configured to flow, which changes the shape of an atomized material cone that is deposited onto the surface from the outlet of the printing nozzle.

In some embodiments, a method of printing a material is provided.

The method may comprise passing a formulation through a print head. In some embodiments, the method comprises mixing two or more parts of the formulation in a printing nozzle of the print head to form a mixture. In some embodiments, the method comprises exposing the formulation to light (e.g., UV light) for e.g., between or equal to 0.01 seconds and 10 seconds, or between or equal to 1 seconds and 3 seconds. In some embodiments, the method comprises exposing the formulation (e.g., mixture) to light at a wavelength within the absorption spectrum of the photoinitiator for e.g., between or equal to 0.01 seconds and 10 seconds, or between or equal to 1 seconds and 3 seconds. In some embodiments, the method comprises flowing compressed gas from the compressed gas source to atomize the formulation as it exits the nozzle. In some embodiments, the method comprises flowing compressed gas from the compressed gas source to atomize the formulation after it exits the nozzle with a predetermined delay.

In some embodiments, the formulation comprises two or more parts, and passing a formulation through the print head involves flowing at least two of the two or more parts of the formulation through a respective material inlet of the two or more material inlets into the printing nozzle. In some embodiments, the formulation comprises three or more parts, and passing a formulation through the print head involves flowing at least three of the three or more parts of the formulation through a respective material inlet of three or more material inlets into the printing nozzle. In some embodiments, the formulation comprises four or more parts, and passing a formulation through the print head involves flowing at least four of the four or more parts of the formulation through a respective material inlet of four or more material inlets into the printing nozzle.

In some embodiments, the formulation comprises molecules that have a UV-curable functional group. In some embodiments, the formulation comprises molecules that have a functional group curable by means other than UV exposure. In some embodiments, the formulation comprises molecules that have a UV-curable functional group, and molecules that have a functional group curable by means other than UV exposure. In some embodiments, some of the molecules that have the UV-curable functional group also have a functional group curable by means other than UV exposure. In some embodiments, the formulation comprises molecules that have an isocyanate functional group. In some embodiments, the formulation comprises molecules that have one or more of an alcohol functional group or an amine functional group. In some embodiments, the formulation comprises molecules that have an alkene functional group and molecules that have one or more of an alcohol functional group, an amine functional group, or an isocyanate functional group. In some embodiments, the formulation (e.g., mixture) comprises alkene groups, isocyanate groups, a photoinitiator, and at least one of alcohol groups or amine groups.

In some embodiments, the method comprises mixing two or more parts of the formulation together to form a mixture that comprises alkene groups (e.g., acrylates, methacrylates, vinyls, etc.), isocyanate groups, a photoinitiator, and at least one of alcohol groups or amine groups. In some embodiments, the method comprises exposing the mixture to light (e.g., UV light) at a wavelength within the absorption spectrum of the photoinitiator (e.g., between or equal to 365 nm and 405 nm). In some such embodiments, the alkene groups in the mixture react with one another to increase the viscosity of the mixture.

The print head may comprise a compressed gas source, a printing nozzle, and/or two or more material inlets in fluid communication with the printing nozzle. In some embodiments, an outlet of the printing nozzle is configured to intersect with an outlet fluidly connected to the compressed gas source. In some embodiments, the print head comprises an ultraviolet (UV) light source adjacent to the printing nozzle. In some embodiments, the printing nozzle comprises a mixing chamber and an impeller disposed in the mixing chamber. In some embodiments, the two or more material inlets are in fluid communication with the mixing chamber.

In some embodiments, the mixture continues to increase in one or more of viscosity, strength, yield stress, or stiffness after UV exposure is finished as a result of reaction between molecules in the mixture that have a functional group curable by means other than UV exposure (e.g., between molecules in the mixture that have isocyanate groups and one or more of alcohol groups and amine groups). In some embodiments, the mixture does not have a yield stress when it reaches an outlet of the printing nozzle (e.g., outlet of the mixing chamber), prior to exposure to UV light. In some embodiments, the mixture develops a yield stress within 2 seconds after exposure to UV light. In some embodiments, the formulation (e.g., the mixture) also includes a photo-latent base, which may act as a catalyst that becomes more active upon exposure to UV irradiation to induce faster reaction of any functional groups in the formulation curable by means other than UV irradiation. The term photo-latent base as used herein refers to a molecule that changes structure in response to UV light to become a new molecule with a larger pKₐ (logarithmic acid dissociation constant).

The following examples are intended to illustrate certain embodiments of the present invention, but do not exemplify the full scope of the invention.

### Example 1

Water-blown polyurethane foam. A mixing nozzle was configured to have two inputs: Input A for an isocyanate pre-polymer, and Input B for a mixture of polyols, surfactants, and water. When the two inputs were combined in the mixing chamber, the water and polyols reacted with the isocyanate to form a polyurethane matrix with a higher number-average molecular weight than the polyols and carbon dioxide that became trapped in the polyurethane matrix to form a foam. Inputs A and B were as follows:

Input A: (one or more of the following components flowed into the mixing nozzle)

| Component | Description | Amount (g) |
|---|---|---|
| Polytech 20-A | Isocyanate prepolymer | 150 |
| BJB enterprises f-115-a | Isocyanate prepolymer | 150 |
| Polytech F-3-A | Isocyanate prepolymer | 110 |
| Polyfiber II | Polyethylene fiber (rheological | 40 |
| | modifier) | |

Input B: (one or more of the following components flowed into the mixing nozzle, in addition to water)

| Component | Description | Amount (g) |
|---|---|---|
| Polytech 20-B | Polyol blend for elastomer | 150 |
| BJB enterprises F-115-B | Polyol blend for soft elastomer | 150 |
| Polytech F-3-B | Polyol, water, surfactant blend | 220 |
| | for foam promotion | |
| 3M S32 glass bubbles | Foam stabilizer and bubble | 42 |
| | nucleation site | |
| Polyfiber II | Polyethylene fiber (rheological | 40 |
| | modifier) | |
| Polytech White | White Pigment | 16 |
| Poly UV | UV stabilizer | 3.38 |
| Evonik Tegostab B 8952 | Silicone surfactant for foam | 10 |
| | stabilizing | |
| Polytek 74/75 part X | Organometallic catalyst | 15.2 |
| accelerator | | |

Such a water-blown polyurethane foam (white, top portion) was co-printed with a non-foaming two-part polyurethane elastomer (blue, bottom portion) to form a shoe sole, as is shown in FIG. 7.

A mean pore size of the foam was characterized by slicing through a 3D-printed filament to obtain a cross-section of the foam and then imaging the cross-section with a light microscope and using image analysis (depicted in FIG. 8 with circles and measurements in microns).

### Example 2

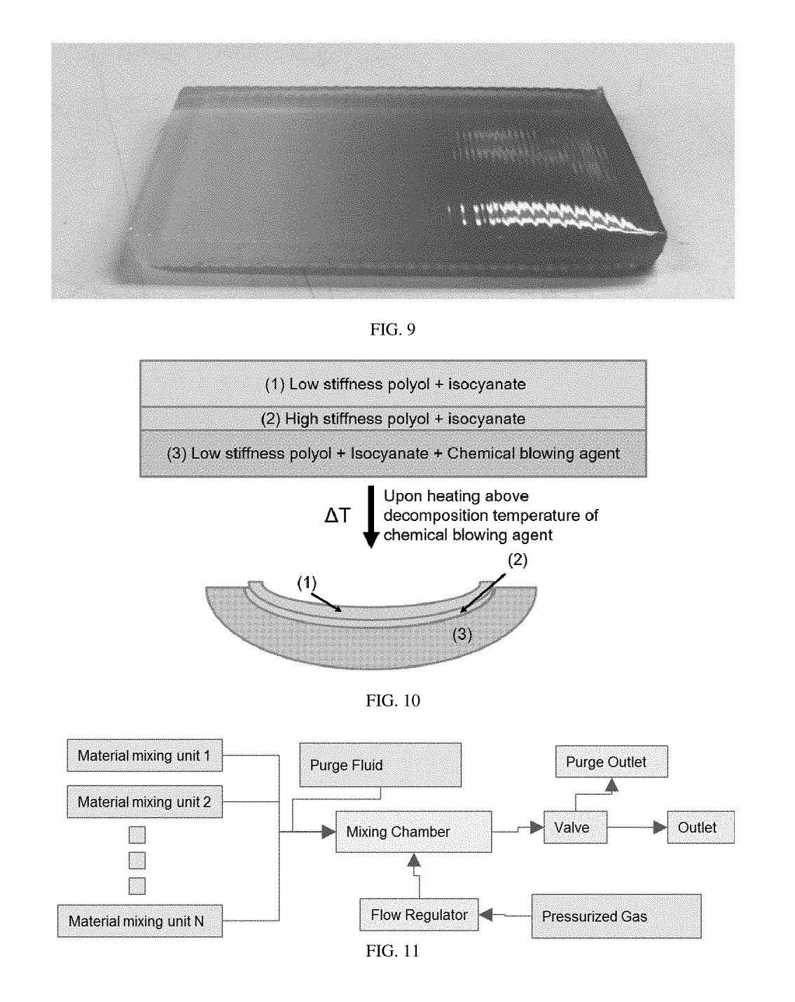

Silicone gradient material. A coupon with a gradient in both stiffness and color was fabricated using a two-input mixing nozzle system, as shown in FIG. 9. The clear-colored silicone (left) was a soft elastomer with a Shore hardness of 10A. The blue colored silicone (right) was a medium hard elastomer with a Shore hardness of 70A. In this example, parts A and B were mixed together to make a precursor to the soft elastomer (Input 1), and parts A′ and B′ were mixed together to make a precursor to the hard elastomer (Input 2) prior to injecting into the mixing chamber. The coupon was printed with each layer as a single meandering print path where the beginning of the print path (left-most position in FIG. 9) was 100% A and B (e.g. 100% Input 1), and the end of the print path (right-most position in FIG. 9) was 100% A′ and B′ (e.g. 100% Input 2). The volume ratio of Input 1 to Input 2 was varied continuously from one side of the 3D-printed coupon to the other.

The inputs were as follows:

Input 1, A and B: (two or more of the following components flowed into the mixing nozzle)

| Component | Description | Amount (g) |
|---|---|---|
| Blue star LSR 4301 A | Part A soft platinum cure | 74 |
| | silicone elastomer | |
| Blue star LSR 4301 B | Part B soft platinum cure | 74 |
| | silicone elastomer | |
| Aerosil 300 | Fumed silica (rheological | 8.9 |
| | modifier) | |

Input 2, A′ and B′: (two or more of the following components flowed into the mixing nozzle)

| Component | Description | Amount (g) |
|---|---|---|
| Quantumn Silicones 229 | Part A′ 60A platinum cure | 25.5 |
| LV-A | silicone gel | |
| Quantumn Silicones 229 | Part B′ 60A platinum cure | 25.5 |
| LV-B | silicone gel | |
| Blue Star LSR 4350 A | Part A′ 50A platinum cure | 8.5 |
| | silicone elastomer | |
| Blue Star LSR 4350 B | Part B′ 50A platinum cure | 8.5 |
| | silicone elastomer | |
| Blue Star LSR 4301 A | Part A′ 1A platinum cure | 10.5 |
| | silicone elastomer | |
| Blue Star LSR 4301 B | Part B′ 1A platinum cure | 10.5 |
| | silicone elastomer | |
| Smooth-on Silc-Pig Blue | Blue pigment | 0.03 |
| Aerosil 300 | Fumed Silica (Rheological | 6.775 |
| | modifier) | |

### Example 3

Mixing cells into a hydrogel. A hydrogel structure is formed using the mixing system. A first input to the mixing nozzle comprises a cross-linking agent for the hydrogel, and a second input to the mixing nozzle comprises an uncross-linked hydrogel precursor. Additional inputs into the mixing nozzle include concentrated cell suspensions of various types, different types of cell media, and concentrates of cell growth factors and chemical signaling agents.

### Example 4

Printing a rigid epoxy foam. A mixing nozzle comprises a mixing/frothing chamber and at least three inputs. A first input is a gas such as nitrogen or air. A second input is a bisphenol-A-based resin such as Epon® Resin 828, with an added surfactant that stabilizes bubbles. A third input is a curing agent for epoxy resin such as a diamine like ethylenediamine. The second and third input are added to the mixing chamber to induce the epoxy resin to cross-link into a solid thermoset. The gas input flowrate can be varied along with the impeller speed to create a rigid thermosetting foam with variable dielectric properties due to air content.

### Example 5

Mixing therapeutics into a biodegradable matrix material. A multi-input system can be used for creating a therapeutic-impregnated matrix of material such as a pill. Inputs include: a solution of a biodegradable polymer with a high degradation rate; a solution of a biodegradable polymer with a low degradation rate; a solution of a first active therapeutic agent; a solution of a second active therapeutic agent; a sugar or flow inducing agent; or another suitable input.

A pill-like architecture can then be 3D-printed, wherein the composition of the pill can be varied spatially. For example, the external part of the pill could be 3D-printed to contain a first therapeutic agent, and the material printed has a fast degradation profile for a quick release of the first therapeutic agent. Then the internal part of the pill may be printed with a material that degrades slowly, and may contain two different types of therapeutic agents. The external surface of the pill may have a printed inert sugar coating so that no therapeutic release occurs until the pill has passed through the esophagus. This allows the possibility of combining many pills into one. By this process, a 3D-printed pill can have a customized therapeutic release profile that is specific to a patient.

The same methodology to 3D-print pills can be applied to 3D-printed implantable long-term therapeutic release depots. For example, this 3D-printing methodology can be applied towards fabricating a skin tissue graft, wherein drugs, growth factors, antibiotics, and cells can be printed with variable spatial concentration to promote the regrowth of a skin defect such as a severe burn. Printing an implantable therapeutic depot may involve an input that induces polymerization or cross-linking.

### Example 6

Printing a rigid epoxy foam: printing a stimuli-responsive structure from a reactive polyurethane system. A system comprising at least four inputs may be used to 3D-print a stimuli-responsive structure, the inputs comprising: an isocyanate cross-linking agent; a polyol mixture wherein the components have low stiffness; a polyol mixture wherein the components have high stiffness; and a chemical blowing agent concentrate dissolved in polyol.

For example, a tri-layer architecture can be 3D-printed to accomplish the stimuli-responsive property. As shown in FIG. 10, the top layer (1) forms a low-stiffness/high-flexibility elastomer from inputs comprising a low-stiffness polyol mixture and an isocyanate. The middle layer (2) in FIG. 10 forms a high-stiffness elastomer from inputs comprising a high stiffness polyol mixture and an isocyanate. Layer (2) functions as a strain-limiting layer. The bottom layer (3) in FIG. 10 initially forms an elastomer with similar properties to the top layer after printing and partial curing, and is formed from inputs comprising a high flexibility polyol mixture, an isocyanate, and a chemical blowing agent. After the entire structure is printed and partially cured, the structure can be heated above the decomposition temperature of the chemical blowing agent. This causes the bottom layer (3) to expand into a foam. However, since layer (3) is chemically and physically bonded to the middle strain-limiting layer (2) that has higher stiffness, the bottom layer (3) will generally expand, but will expand to a lesser extent at the interface of the strain-limiting material. This differential strain will cause the entire structure to curl. Thus, FIG. 10 illustrates a 3D-printed stimuli-responsive tri-layer polyurethane system, where heating results in curling of the tri-layer structure (Example 6)

The expansion of the bottom material upon decomposition of the chemical blowing agent, coupled with the strong interface with the strain-limiting layer, causes a physical curling of the whole tri-layer structure. Selective placement of the expandable material containing the blowing agent can be utilized to programmatically define deformations in printed parts that will not occur until after the part is printed and heated.

### Example 7

There are multiple system configurations that may enable zonal tuning of material properties, and this example describes some of these configurations.

In configuration 1, Input 1 may include an isocyanate prepolymer blend with an isocyanate group content in range of e.g. 6%-35%. In configuration 1, Input 2 may include a high molecular weight polyol system that includes blend of diols and triols with: functionality range of e.g. 2-3; average molecular weight range of e.g. 500-7000; and viscosity range (at 1/s shear rate) of e.g. 1000-100,000 cPs. In configuration 1, Input 3 may include a high molecular weight polyol system including blends of diols and triols with average molecular weight e.g. greater than 500, and a high loading of thixotropic/thickening additive like fumed silica (Same polyol equivalent weight as Input 2): average molecular weight range of e.g. 500-7000; viscosity range (at 1/s shear rate) of e.g. 100,000-5,000,000 cPs; and functionality range of e.g. 2-3. In configuration 1, Input 4 may include a low molecular weight polyol/chain extender having: average molecular weight range of e.g. 1-1000; viscosity range (at 1/s shear rate) of e.g. 1000-5,000,000 cPs; and functionality range of e.g. 2-3.

In terms of where the additives are in configuration 1, e.g. catalyst, stabilizers, fillers, and/or pigments may be incorporated into all of the polyol systems. All inputs may contain some small amount of thixotrope/thickener.

Regarding how configuration 1 may be used, software may define the target material stiffness and target material viscosity and target extrusion cross sectional area for a particular printed region. A composite equivalent weight of polyol blend may be chosen to approximate the target stiffness. The ratio of Input 4 to Inputs 2 and/or 3 may be chosen to achieve this composite equivalent weight. The thixotrope/thickener content may be chosen to best approximate target viscosity. The ratio of input 2 to input 3 may be chosen to achieve this concentration after blending with inputs 1 and 4. The ratio of (Input 1-isocyanate):(input 2+input 3+input 4) may be chosen in order to index the isocyanate appropriately. Extrusion volumes for each input may be scaled, while holding the set ratios constant, in order to achieve software defined extrusion cross sectional area at the desired print speed.

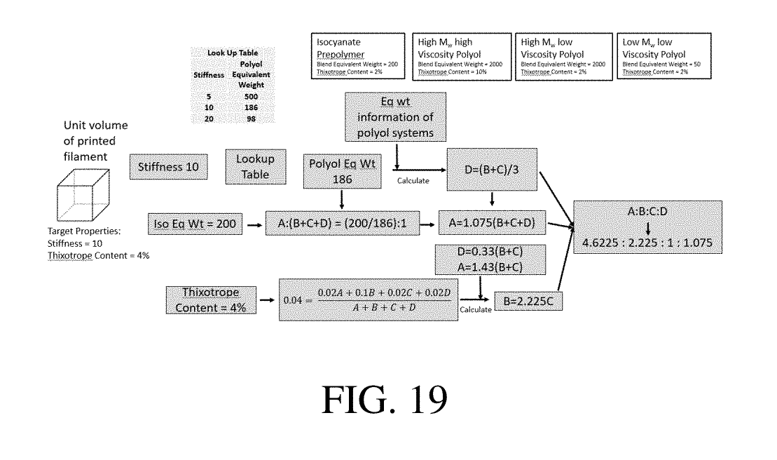

FIG. 19 demonstrates one possible flow of calculations that may be used to evaluate the required material input ratios to achieve the target material properties. In this case the lookup tables and the blend equivalent weight information may be stored data in the system, then an algorithm may use that information to calculate the ratios required to hit the target properties. This particular example describes a workflow for Configuration 1 herein described.

In configuration 2, Input 1 may include a high functionality isocyanate prepolymer blend with an isocyanate group content range of e.g. 18%-35%. In configuration 2, Input 2 may include a low functionality isocyanate prepolymer blend with an isocyanate group content range of e.g. 6%-18%. In configuration 2, Input 3 may include a High Viscosity Polyol System with: average molecular weight range of e.g. 1-7000; viscosity range (at 1/s shear rate) of e.g. 100,000-5,000,000 cPs; and functionality range of e.g. 2-3. In configuration 2, Input 4 may include a Low Viscosity Polyol system having: average molecular weight range of e.g. 1-7000; viscosity range (at 1/s shear rate) of e.g. 10-100,000 cPs; and functionality range of e.g. 2-3.

The logic of using the system of configuration 2 is similar to utilizing the configuration 1 system, however, rather than using input 4 concentration to control the ratio of hard to soft segment in the system, the ratio of input 1 to input 2 may be used to control the ratio of hard to soft segment in the system.

Configuration 1 may be implemented to control the material stiffness and the material viscosity independently. In order to control another set of properties, such as stiffness and cure speed, this configuration could be altered by e.g. substituting a material for input 3.

If for example input 3 is the same viscosity, molecular weight, and functionality as input 2, but with a much higher concentration of catalyst, then the ratio of input 2 to input 3 may be modulated to control cure rate or gel time.

If for example input 3 is the same viscosity, molecular weight, and functionality as input 2, but with small amounts of added water and surfactant, then the ratio of input 2 to input 3 may be modulated to control foaming and foam density.

If for example input 3 is the same viscosity, molecular weight, and functionality as input 2, but with added pigment of some color, then the ratio of input 2 to input 3 may be modulated to control the intensity of that color or pigment.

If for example input 3 is the same viscosity, molecular weight, and functionality as input 2, but with added blowing agent, then the ratio of input 2 to input 3 may be used to define how much the material expands when the printed material is exposed to temperatures above the decomposition temperature of the blowing agent.

It should be understood that the specific embodiments in Example 7 are just some of the possible combinations for this system. Other properties may be changed by e.g. substituting the composition of the inputs. The embodiments also need not all modulate stiffness. It should also be understood that the configurations listed above are specific to a mixing nozzle with 4 inputs for active materials. If one of these embodiments were extended to more than 4 inputs, then more than two properties could be controlled simultaneously. A similar system could be used with 6 inputs to control e.g. stiffness, viscosity, cure rate, and density independently. A system with 8 inputs could be used to control e.g. stiffness, viscosity, and full CMYK or RGB color.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When the word “about” is used herein in reference to a number, it should be understood that still another embodiment of the invention includes that number not modified by the presence of the word “about.”

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method for printing an article, comprising:
flowing a first fluid through a first inlet into a microfluidic printing nozzle;
flowing a second fluid through a second inlet into the microfluidic printing nozzle;
flowing at least one additional fluid through at least one additional inlet into the microfluidic printing nozzle;
actively mixing the first fluid, the second fluid, and the at least one additional fluid in the microfluidic printing nozzle to form a mixture; and
depositing the mixture onto a substrate.

2. The method of claim 1, wherein the first fluid contains isocyanate functional groups.

3-4. (canceled)

5. The method of claim 1, wherein the second fluid contains alcohol functional groups and/or amine functional groups.

6-41. (canceled)

42. A method of printing of an article, comprising:
receiving object information associated with the article;
identifying, using the object information, characteristics of a target material to be printed at each location of a machine tool path that will be used to create the article;
identifying two or more input materials to create the target material;
identifying a set of printer settings for printing the target material;
generating print instructions using the set of printer parameters; and
printing the article using the print instructions.

43. The method of claim 42, comprising calculating the ratios of at least two material inputs to a microfluidic printing nozzle required to achieve the target material characteristics in each location.

44-45. (canceled)

46. The method of claim 42, wherein the system uses at least 3 inputs.

47-62. (canceled)

63. A method of printing an article, comprising:
flowing at least two materials into a mixing chamber, wherein at least one of the materials is polymeric;
mixing the at least two materials in the mixing chamber containing an impeller to form a mixture; and
depositing the mixture onto a textile.

64. The method of 63, comprising flowing the at least two materials into the mixing chamber while rotating the impeller in the mixing chamber.

65. The method of claim 63, wherein the mixing chamber contains at least a portion of the impeller.

66-147. (canceled)

148. A method, comprising:
mixing a first fluid and a second fluid in a first mixing chamber to form a first mixture;
flowing the first mixture out of a first nozzle;
depositing the first mixture onto a substrate to form a layer;
inkjetting one or more additional layers of the first mixture on top of the first layer;
mixing a third fluid and a fourth fluid in a second mixing chamber to form a second mixture;
flowing the second mixture out of a second nozzle; and
depositing the second mixture on top of an inkjetted layer of the first mixture.

149. The method of claim 148, wherein the first mixing chamber and the second mixing chamber are the same.

150. The method of claim 148, wherein the first nozzle and the second nozzle are the same.

151-160. (canceled)

161. A method, comprising:
passing a formulation through a print head, the print head comprising:
a compressed gas source;
a printing nozzle; and
two or more material inlets in fluid communication with the printing nozzle;
wherein an outlet of the printing nozzle is configured to intersect with an outlet fluidly connected to the compressed gas source.

162. A method, comprising:
passing a formulation through a print head, the print head comprising:
a printing nozzle;
two or more material inlets in fluid communication with the printing nozzle; and
an ultraviolet (UV) light source adjacent to the printing nozzle.

163. The method of claim 161, wherein the printing nozzle comprises:
a mixing chamber; and
an impeller disposed in the mixing chamber;
wherein the two or more material inlets are in fluid communication with the mixing chamber.

164. The method of claim 161, wherein the formulation comprises two or more parts, and wherein passing a formulation through the print head involves flowing at least two of the two or more parts of the formulation through a respective material inlet of the two or more material inlets into the printing nozzle.

165. The method of claim 161, wherein an outlet of the printing nozzle is configured to intersect with an outlet fluidly connected to the compressed gas source.

166. The method of claim 161, wherein the formulation comprises molecules that have a UV-curable functional group.

167. The method of claim 161, wherein the formulation comprises molecules that have a functional group curable by means other than UV exposure.

168. The method of claim 161, wherein the formulation comprises molecules that have a UV-curable functional group, and molecules that have a functional group curable by means other than UV exposure.

169-182. (canceled)
